(19) United States
(12) Patent Application Publication
(10) Pub. No.: US 2014/0354574 A1
(43) Pub. Date: Dec. 4, 2014

(54) ELECTRONIC APPARATUS

(71) Applicant: Panasonic Corporation, Osaka (JP)

(72) Inventors: Yoshitaka Hirabayashi, Osaka (JP); Koichi Ikemoto, Hyogo (JP); Susumu Fukushima, Osaka (JP)

(21) Appl. No.: 14/372,420

(22) PCT Filed: Jan. 24, 2013
(86) PCT No.: PCT/JP2013/000339

§ 371 Date: Jul. 15, 2014

(30) Foreign Application Priority Data
Jan. 27, 2012 (JP) 2012-015192
Jun. 14, 2012 (JP) 2012-134909
Jun. 15, 2012 (JP) 2012-135513

(51) Int. Cl. G06F 3/041

(52) U.S. Cl. CPC G06F 3/041
USPC 345/173

(57) ABSTRACT

An electronic apparatus includes a touch panel, an acceleration detector, an angular velocity detector, and a controller. The touch panel has an operation surface, and detects a contact with the operation surface and outputs a contact detection signal. The acceleration detector detects an acceleration of the electronic apparatus, and outputs an acceleration signal. The angular velocity detector detects an angular velocity of the electronic apparatus, and outputs an angular velocity signal. The controller is connected to the touch panel, the acceleration detector, and the angular velocity detector. When the acceleration signal is input from the acceleration detector and the angular velocity signal is input from the angular velocity detector, the controller outputs the contact detection signal as a contact determination signal.

### TECHNICAL FIELD

The present invention relates to an electronic apparatus such as a portable phone, an electronic book, and a tablet information terminal.

### BACKGROUND ART

FIG. 20 shows input device 1 included in a conventional electronic apparatus. Input device 1 detects the position and area of contact part 3 of a user's finger on input surface 2, compares the detected area of contact part 3 with a preset threshold, and determines the position as an input position when the area is the threshold or larger (for example, Patent Literature 1).

### CITATION LIST

### Patent Literature

PTL 1 Unexamined Japanese Patent Publication No. 2011-43987

### SUMMARY OF THE INVENTION

The present invention is an electronic apparatus that achieves accurate input determination. A first electronic apparatus of the present invention includes a touch panel, an acceleration detector, an angular velocity detector, and a controller. The touch panel has an operation surface, and detects a contact with the operation surface and outputs a contact detection signal. The acceleration detector detects the acceleration of the electronic apparatus, and outputs an acceleration signal. The angular velocity detector detects the angular velocity of the electronic apparatus, and outputs an angular velocity signal. The controller is connected to the touch panel, acceleration detector, and angular velocity detector. When the acceleration signal is input from the acceleration detector and the angular velocity signal is input from the angular velocity detector, the controller outputs the contact detection signal as a contact determination signal. A second electronic apparatus of the present invention includes a touch panel, a casing, an acceleration detector, an angular velocity detector, and a controller. The touch panel has an operation surface, and detects a contact with the operation surface and outputs a contact detection signal. The casing supports the touch panel. The acceleration detector detects the acceleration of the electronic apparatus, and outputs an acceleration signal. The angular velocity detector detects the angular velocity of the electronic apparatus, and outputs an angular velocity signal. The controller is connected to the touch panel, acceleration detector, and angular velocity detector. The controller outputs a contact determination signal based on the contact detection signal, acceleration signal, and angular velocity signal. When the contact detection signal is not input, the acceleration signal is input, and the angular velocity signal is input, the controller determines that an input operation to the casing is performed and outputs an input determination signal

### BRIEF DESCRIPTION OF DRAWINGS

FIG. 1 is a block diagram of an electronic apparatus in accordance with a first exemplary embodiment of the present invention.

FIG. 2 is a perspective view of the electronic apparatus shown in FIG. 1.

FIG. 3 is a flowchart showing an operation of the electronic apparatus shown in FIG. 1.

FIG. 4A is a diagram showing an output waveform of an acceleration when the electronic apparatus shown in FIG. 1 is operated.

FIG. 4B is a diagram showing an output waveform of an angular velocity when the electronic apparatus shown in FIG. 1 is operated.

FIG. 5 is a flowchart showing another operation of the electronic apparatus shown in FIG. 1.

FIG. 6 is a flowchart showing yet another operation of the electronic apparatus shown in FIG. 1.

FIG. 7 is a flowchart showing still another operation of the electronic apparatus shown in FIG. 1.

FIG. 8 is a perspective view of an electronic apparatus in accordance with a second exemplary embodiment of the present invention.

FIG. 9 is a flowchart showing an operation of the electronic apparatus shown in FIG. 8.

FIG. 10A is a diagram showing an input example to an electronic apparatus in accordance with a third exemplary embodiment of the present invention.

FIG. 10B is a diagram showing another input example to the electronic apparatus in accordance with the third exemplary embodiment of the present invention.

FIG. 11 is a flowchart showing an operation of the electronic apparatus shown in FIG. 10A and FIG. 10B.

FIG. 12A is a front view of the electronic apparatus in accordance with the third exemplary embodiment of the present invention.

FIG. 12B is a rear view of the electronic apparatus shown in FIG. 12A.

FIG. 13A is a front view of another electronic apparatus in accordance with the third exemplary embodiment of the present invention.

FIG. 13B is a rear view of the electronic apparatus shown in FIG. 13A.

FIG. 14 is a front view of yet another electronic apparatus in accordance with the third exemplary embodiment of the present invention.

FIG. 15 is a perspective view of an electronic apparatus in accordance with a fourth exemplary embodiment of the present invention.

FIG. 16 is a flowchart showing an operation of the electronic apparatus shown in FIG. 15.

FIG. 17A is a diagram showing an output waveform of an acceleration detected when a finger is pressed following a state where the finger is in contact with a touch panel.

FIG. 17B is a diagram showing an output waveform of an angular velocity detected when a finger is pressed following a state where the finger is in contact with the touch panel.

FIG. 18A is a diagram showing an output waveform of a typical acceleration detected during a normal finger pressing action.

FIG. 18B is a diagram showing an output waveform of a typical angular velocity detected during the normal finger pressing action.

FIG. 19 is a flowchart showing an operation of an electronic apparatus in accordance with a fifth exemplary embodiment of the present invention.

FIG. 20 is a diagram showing an input device of a conventional electronic apparatus.

### DESCRIPTION OF EMBODIMENTS

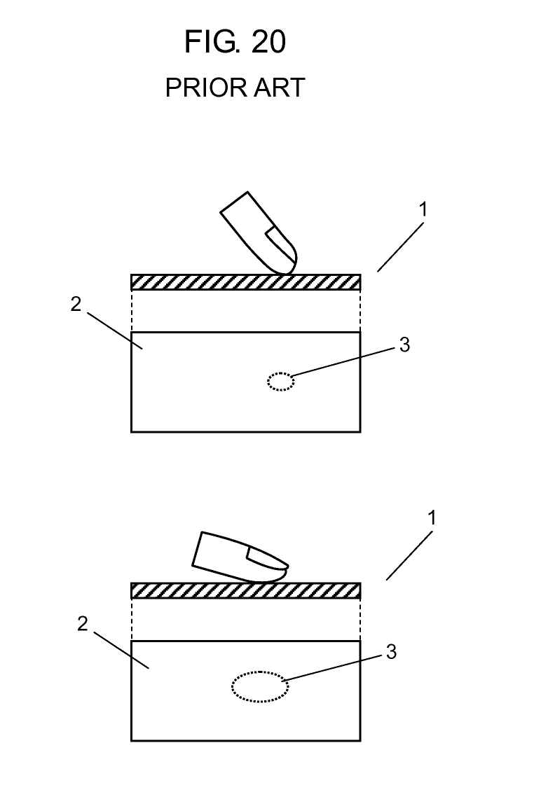

Prior to the descriptions of exemplary embodiments of the present invention, problems of input device 1 shown in FIG. 20 are described. When an object comes into contact with input surface 2 in a certain area or larger, input device 1 detects the contact as an input operation regardless whether or not the contact is intended by a user. For example, even when a finger or the like comes into contact with input surface 2 without intending input during an operation of input device 1, input device 1 detects the contact as an input operation. When a user touches input surface 2 without intending an input operation, however, the user does not firmly press input surface 2. Therefore, an acceleration or an angular velocity does not occur, or is extremely low, in input device 1.

Even when a something comes into contact with input surface 2 in a state where input device 1 is placed on a desk, an acceleration or an angular velocity does not occur in input device 1. Also in this case, however, input surface 2 is pressed and hence input device 1 detects the pressing as an input operation.

On the other hand, an object with a certain contact area or smaller does not allow an input operation. For example, input device 1 cannot detect an operation with a nail or pen as an input operation. When a user intends an input operation with a small contact area, the user firmly presses input surface 2 and hence an acceleration or an angular velocity occurs in input device 1.

Hereinafter, various exemplary embodiments of the present invention are described. In each exemplary embodiment, elements similar to those in the preceding exemplary embodiment(s) are denoted with the same reference marks, and the detailed descriptions of those elements may be omitted.

### First Exemplary Embodiment

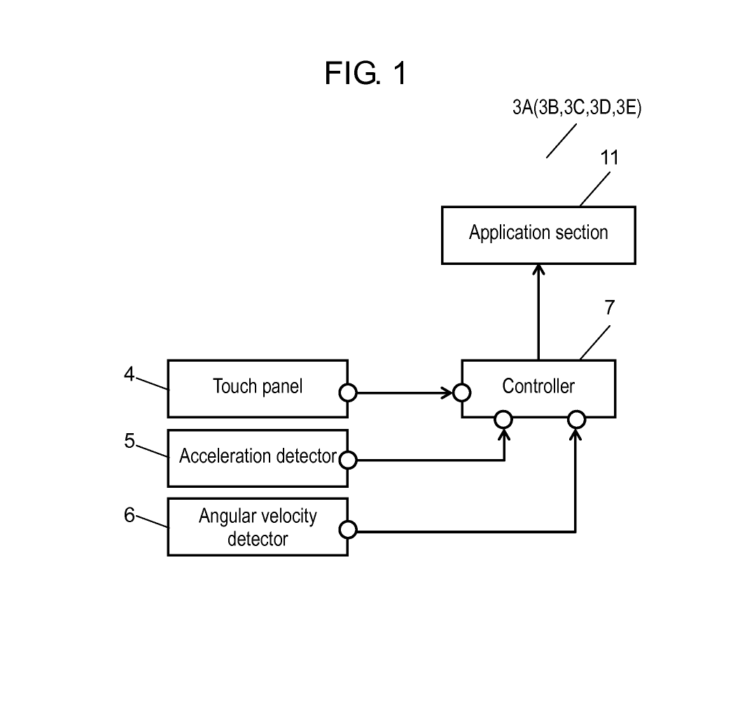

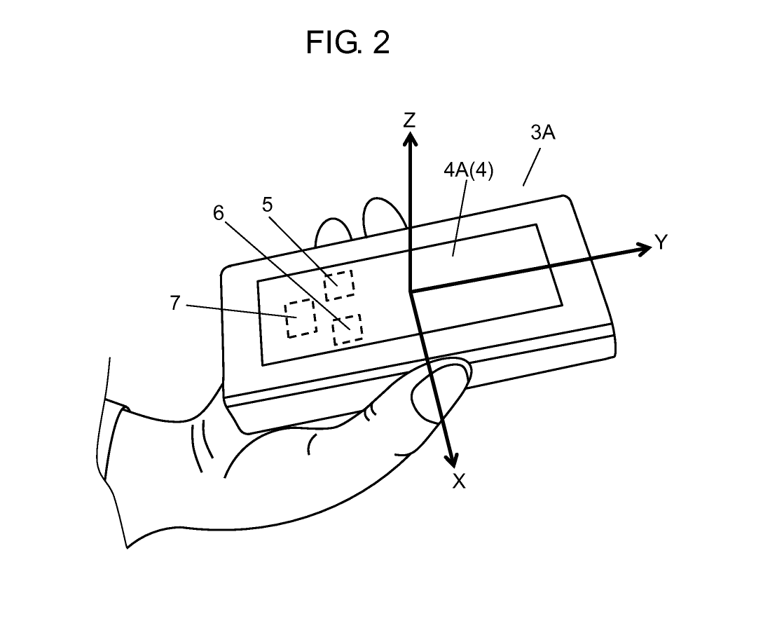

Electronic apparatus 3A of the first exemplary embodiment of the present invention is described hereinafter with reference to the accompanying drawings. FIG. 1 is a block diagram of electronic apparatus 3A. FIG. 2 is a perspective view of electronic apparatus 3A.

Electronic apparatus 3A includes touch panel 4, acceleration detector 5, angular velocity detector 6, controller 7, and application section 11. Touch panel 4 has operation surface 4A, detects that a finger, a thumb, or the like comes into contact with operation surface 4A, and outputs a contact detection signal. Acceleration detector 5 detects an acceleration of electronic apparatus 3A, and outputs an acceleration signal. Angular velocity detector 6 detects an angular velocity of electronic apparatus 3A, and outputs an angular velocity signal. Controller 7 is connected to touch panel 4, acceleration detector 5, and angular velocity detector 6. When controller 7 receives an acceleration signal from acceleration detector 5 and receives an angular velocity signal from angular velocity detector 6, controller 7 outputs, to application section 11, a contact detection signal output from touch panel 4 as a contact determination signal. Application section 11 is a display disposed on the rear surface of touch panel 4, for example. Thanks to this configuration, electronic apparatus 3A can accurately operate in response to the input operation.

Specifically, when controller 7 receives a contact detection signal from touch panel 4, based on the variation amount in acceleration at that time and the variation amount in angular velocity at that time, controller 7 determines whether the contact with touch panel 4 is an input operation which is intentionally performed by a user with his/her finger. The input operation is hereinafter referred to as “finger pressing action”. When the contact is determined to be a finger pressing action, controller 7 determines that the contact detection signal indicates an input operation to the touch panel, and outputs the contact detection signal as a contact determination signal to application section 11.

As shown in FIG. 2, when the surface of electronic apparatus 3A on which operation surface 4A is disposed is substantially rectangular, it is assumed that the longitudinal direction is Y axis, the lateral direction is X axis, and the direction perpendicular to the X-Y plane formed of the X axis and Y axis is Z axis. The center of touch panel 4 is assumed to be an origin.

Acceleration detector 5 detects an acceleration applied to electronic apparatus 3A along a predetermined direction, and sends an acceleration signal related to the detected acceleration to controller 7. Here, the predetermined direction means a direction in which variation in acceleration of electronic apparatus 3A by the finger pressing action to touch panel 4 can be detected. The variation in acceleration of electronic apparatus 3A by the finger pressing action to touch panel 4 is detected mainly as acceleration of electronic apparatus 3A in the Z axis direction. Therefore, in order to detect the acceleration of electronic apparatus 3A, an acceleration sensor capable of detecting the acceleration of electronic apparatus 3A in the Z axis direction is used as acceleration detector 5.

Angular velocity detector 6 detects an angular velocity applied to electronic apparatus 3A around the X axis, and sends an angular velocity signal related to the detected angular velocity to controller 7. In order to detect the angular velocity of electronic apparatus 3A, an angular velocity sensor capable of detecting the angular velocity of electronic apparatus 3A around the X axis is used as angular velocity detector 6. As the angular velocity sensor, a multi-axis angular velocity sensor capable of detecting angular velocity around two axes or three axes may be employed (described later).

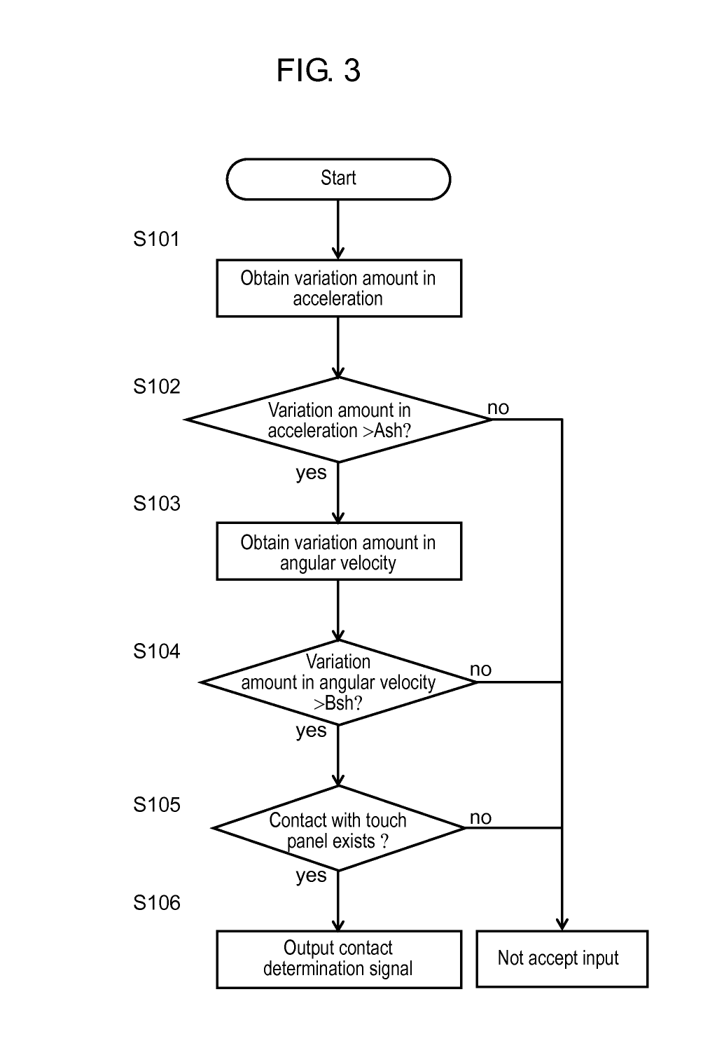

Next, an input determination method is described with reference to FIG. 3. FIG. 3 is a flowchart showing an operation of electronic apparatus 3A.

In S101, controller 7 calculates the variation amount in acceleration based on the acceleration signal sent from acceleration detector 5. In S102, controller 7 determines whether the variation amount (magnitude) in acceleration calculated in S101 exceeds preset threshold Ash. When it exceeds the threshold, the process goes to S103. When it does not exceed the threshold, controller 7 determines the input of the acceleration signal to be ineffective and does not accept the input.

In S103, controller 7 calculates the variation amount in angular velocity based on the angular velocity signal sent from angular velocity detector 6. In S104, controller 7 determines whether the variation amount (magnitude) in angular velocity calculated in S103 exceeds preset threshold Bsh. When it exceeds the threshold, the process goes to S105. When it does not exceed the threshold, controller 7 determines the input of the angular velocity signal to be ineffective and does not accept the input.

In S105, touch panel 4 outputs a contact detection signal to controller 7 when a finger comes into contact with operation surface 4A. When the contact detection signal is input to controller 7, controller 7 determines the input of the contact detection signal to be effective and outputs it as a contact determination signal to application section 11 (S106). When the contact detection signal is not input to controller 7 simultaneously with variation in acceleration and angular velocity, controller 7 determines the input of the acceleration signal and angular velocity signal to be ineffective and does not accept the input of them.

Application section 11 executes a processing operation corresponding to the contact determination signal. The processing operation at this time may be an operation of causing an event in response to the presence or absence of an input, or an operation of causing an event in response to a region having undergone the input. In other words, the application based on the contact determination signal is not limited to a specific processing operation.

While, when the input of the acceleration signal and angular velocity signal is determined to be ineffective, controller 7 does not send application section 11 any contact determination signal. In other words, when this contact occurs, application section 11 does not execute the processing.

Thus, in electronic apparatus 3A, controller 7 determines whether or not the input operation by a contact is effective, based on the contact detection signal from touch panel 4, the acceleration signal from acceleration detector 5, and the angular velocity signal from angular velocity detector 6. Therefore, for example, even when a finger or the like comes into contact with touch panel 4 without intending input during the operation of electronic apparatus 3A, controller 7 does not output the contact detection signal as the contact determination signal differently from the conventional electronic apparatus. The possibility of a malfunction by such an unintended input can be therefore reduced. Thus, in electronic apparatus 3A, a false input by unintended contact with touch panel 4 can be prevented, and input accuracy can be improved. An input with a small-area by a nail or a tool can be accepted.

When an electronic apparatus is operated on a travelling train or vehicle, the acceleration sensor detects vibration of the train or the like, and hence it can be difficult to recognize the variation in acceleration due to the finger pressing action. Even in this case, the angular velocity is not affected by vibration of the train or the like. Therefore, controller 7 of electronic apparatus 3A can accurately determine a finger pressing action, so that the input accuracy can be improved.

In S102 and S104, the thresholds for determining the magnitudes of the acceleration and angular velocity may be varied from one user to another. The amplitudes of the acceleration and angular velocity caused by the finger pressing action are apt to vary from one user to another. By setting the thresholds in accordance with the amplitudes, the input operation can be determined more accurately and the input accuracy can be improved. The thresholds may be set by input from touch panel 4, or may be set by input from an additional dedicated input section.

The configuration has been described where, in S102 and S104, the determination is performed based on whether the variation amount in acceleration and the variation amount in angular velocity exceed thresholds. However, the determination may be performed based on whether the absolute values of the acceleration and the absolute value of the angular velocity exceed thresholds. In this case, the input operation can be determined with a simpler configuration. Furthermore, the calculation amount of controller 7 required for the determination of the input operation can be reduced.

The determination sequence may be changed. For example, S105 may be executed before S101. In this case, when controller 7 receives a contact detection signal from touch panel 4, controller 7 calculates, in S101, the variation amount in acceleration between before and after it receives the contact detection signal, and calculates, in S103, the variation amount in angular velocity between before and after it receives the contact detection signal. Thus, the calculation amount of controller 7 can be reduced.

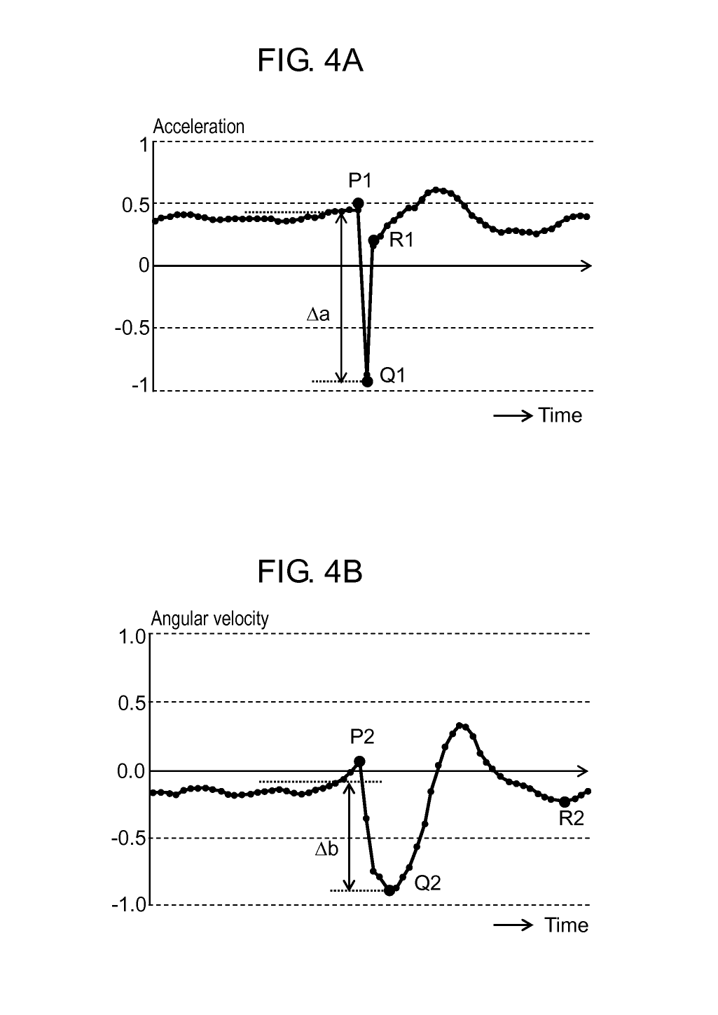

Next, an example of the specific calculation method of the acceleration and angular velocity is described with reference to FIG. 4A and FIG. 4B. FIG. 4A and FIG. 4B show typical output waveforms of the acceleration and angular velocity when touch panel 4 undergoes a finger pressing action, respectively. The horizontal axes show time, and the vertical axes show the magnitudes of the detected acceleration and angular velocity, respectively. In FIG. 4A, point P1 shows the time at which contact with touch panel 4 occurs, and point Q1 shows the time at which the acceleration caused by the contact takes an extreme value.

Variation amount in acceleration Δa is obtained by calculating the difference between the average of the acceleration values immediately before point P1 and the acceleration value at point Q1. In this method, the variation amount can be calculated without being affected by noise acting on acceleration detector 5. For example, the variation amount in acceleration can be calculated without being affected by gravitational acceleration acting on electronic apparatus 3A. Therefore, determination accuracy can be improved.

The calculating method of the variation amount may be any method as long as the offset of the acceleration sensor included in acceleration detector 5 and the noise of gravitational acceleration or the like can be removed. The present invention is not limited to the above-mentioned method.

Similarly to the calculating method of the variation amount in acceleration, the calculating method of variation amount in angular velocity Δb may be any method as long as the noise such as the offset of the angular velocity sensor included in angular velocity detector 6 can be removed. One specific example is described with reference to FIG. 4B. Point P2 shows the time at which contact with touch panel 4 occurs, and point Q2 shows the time at which the angular velocity caused by the contact takes an extreme value. Variation amount in angular velocity Δb is obtained by calculating the difference between the average of the angular velocity values immediately before point P2 and the angular velocity value at point Q2.

In S102 and S104, a determination method may be employed in which the input of the acceleration and angular velocity is determined to be ineffective when the periods of the acceleration and angular velocity detected in response to the contact exceed a predetermined time. More specifically, when the period between the time (point P1 in FIG. 4A) at which the contact with touch panel 4 causes acceleration and the time (point R1 in FIG. 4A) at which the occurring acceleration substantially steadies down exceeds a predetermined period, the input of the acceleration is determined to be ineffective. Alternatively, when the period between the time (point P2 in FIG. 4B) at which the contact with touch panel 4 causes angular velocity and the time (point R2 in FIG. 4B) at which the occurring angular velocity substantially steadies down exceeds a predetermined period, the input of the angular velocity is determined to be ineffective.

According to experiments, the periods of the acceleration and angular velocity caused by a finger pressing action remain within a certain period. Therefore, when the detected periods of the acceleration and angular velocity exceed the period of time, the input is determined to be ineffective. Thus, the input operation can be determined more accurately, and the input accuracy can be improved.

In the present exemplary embodiment, the angular velocity sensor for detecting angular velocity around the Y axis is employed in angular velocity detector 6. However, a multi-axis angular velocity sensor for detecting angular velocity around two axes or three axes may be employed. For example, when a two-axis angular velocity sensor for detecting the angular velocities around the X axis and the Y axis is employed, the above-mentioned determination may be performed based on the variation amount in each of angular velocities around the X axis and the Y axis. In this case, using angular velocity values about a plurality of axes can further improve the determination accuracy.

The threshold as a determination reference for the input operation of the acceleration may be varied in response to the coordinates on touch panel 4. In this case, experiments have shown that, when a something comes into contact with a position near a grasped part of electronic apparatus 3A, the acceleration caused by the contact is small, for example. Therefore, in a place near the grasped part of electronic apparatus 3A, by setting the threshold as the input determination reference of acceleration to be small, the determination accuracy can be further improved.

Also regarding angular velocity, similarly, the threshold as the determination reference of the input operation of the angular velocity may be varied in response to the coordinates. In this case, according to experiments, the angular velocity occurring in electronic apparatus 3A is larger when a something comes into contact with the outer edge of electronic apparatus 3A than when a something comes into contact with the proximity of the center thereof. Therefore, by setting the threshold so that the corresponding threshold increases from the center of touch panel 4 toward the outer edge thereof, the determination accuracy can be further improved.

In the above-mentioned determination method, the input determination is performed based on whether or not the variation amount in angular velocity exceeds a threshold. However, the input determination may be performed based on whether or not a combined value of variation amount in acceleration Δa and variation amount in angular velocity Δb exceeds a threshold. One specific example of the calculation includes a method of performing the determination using preset threshold T based on following equation (1),

\sqrt{Δa²+Δb²}>T. (1)

In this case, for example, the displacement of electronic apparatus 3A caused by contact is small in a region near a grasped part of electronic apparatus 3A, so that the acceleration detected in response to the contact is apt to be small. Electronic apparatus 3A is hardly rotated by contact in a region near the center of touch panel 4, so that the angular velocity detected in response to the contact is apt to be small. Also in such cases, by using the determination based on equation (1), the input can be determined to be effective when any one of the acceleration and angular velocity is sufficiently large. Therefore, the determination accuracy can be further improved.

The present exemplary embodiment has described the case where an input to the touch panel is performed with a finger or a thumb. However, the tool used for the input is not limited to the finger. For example, a nail or pen may be employed. In this configuration, the tool used for the input is not limited, and the operability of the electronic apparatus is improved.

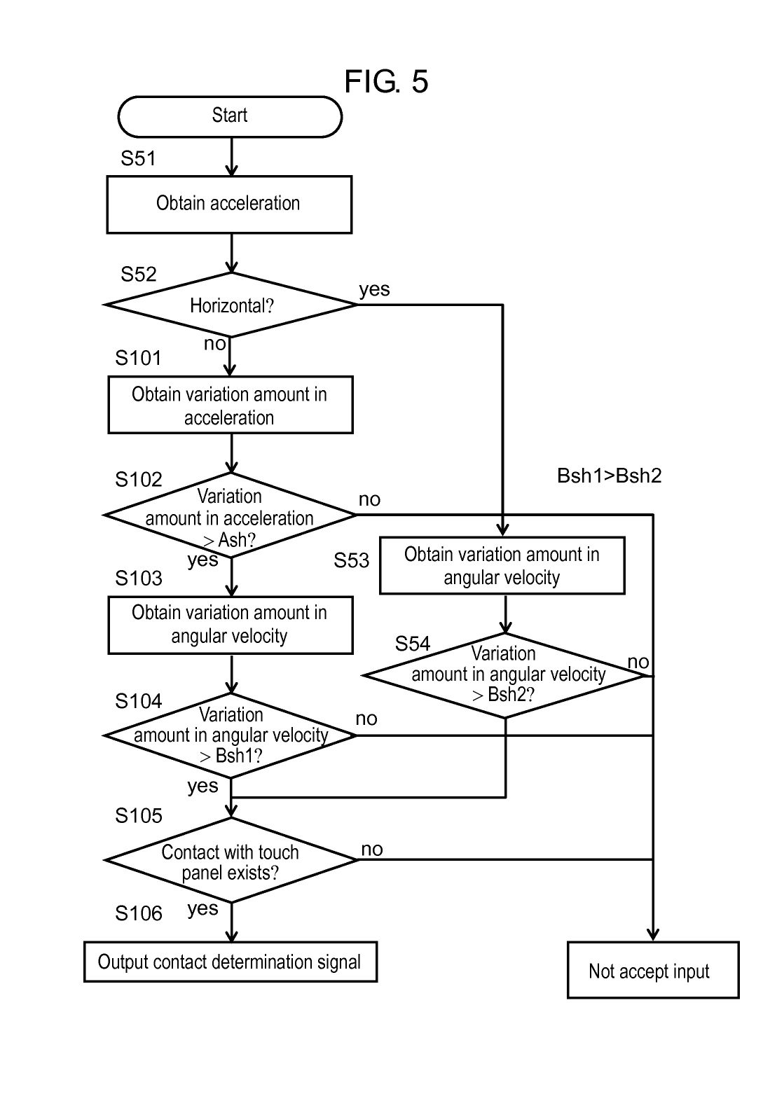

Next, a configuration of more accurately detecting an input operation is described with reference to FIG. 5. FIG. 5 is a flowchart showing another operation of the electronic apparatus shown in FIG. 1. S101 to S106 are the same as those in FIG. 3. Steps different from those in FIG. 3 are described hereinafter. The operation shown in FIG. 5 shows a control procedure corresponding to the case where electronic apparatus 3A is placed on a flat plane such as the upper surface of a desk and the angular velocity hardly occurs.

In S51, controller 7 obtains the acceleration value from acceleration detector 5. When electronic apparatus 3A is horizontally placed in a flat place, the acceleration value in the Z axis direction is substantially equal to 9.8G, gravitational acceleration. When the gravitational acceleration is continuously detected for 0.1 sec or longer (Yes in S52), for example, controller 7 determines that electronic apparatus 3A is in a horizontal and stable state, and the process goes to S53. When controller 7 determines that electronic apparatus 3A is not in a horizontal and stable state (No in S52), the process goes to S101, and controller 7 operates as same as in FIG. 3.

In S53, controller 7 calculates the variation amount in angular velocity of electronic apparatus 3A. The operation in this step is the same as that in S103. In S54, controller 7 determines whether or not the variation amount in angular velocity calculated in S53 exceeds predetermined threshold Bsh2. When it exceeds the threshold, the process goes to S105. When it does not exceed the threshold, controller 7 determines the input of the angular velocity to be ineffective and does not accept the input. Here, considering that electronic apparatus 3A is in a horizontal and stable state and hardly rotates, threshold Bsh2 is set smaller than threshold Bsh1 of S104.

Thanks to this control, also when electronic apparatus 3A is placed on a horizontal and flat surface and angular velocity hardly occurs, a finger pressing action can be accurately detected. Thus, controller 7 reduces the predetermined threshold related to the angular velocity on the basis of the acceleration signal. Thanks to this configuration, also when electronic apparatus 3A is placed on a flat plane such as the upper surface of a desk and the angular velocity is hardly generated, a finger pressing action can be accurately detected.

In the above-mentioned description, a configuration has been described where controller 7 calculates the variation amount in angular velocity in S53 and performs determination in S54 based on the calculated variation amount in angular velocity. However, the condition used for the determination is not limited to this. Specifically, controller 7 may calculate the variation amount in acceleration in S53 and may perform determination in S54 based on the calculated variation amount in acceleration. In this case, the determination can be performed solely by acceleration detector 5, and hence the determination can be performed with a simpler configuration. Alternatively, a combination of angular velocity and acceleration may be used for the determination.

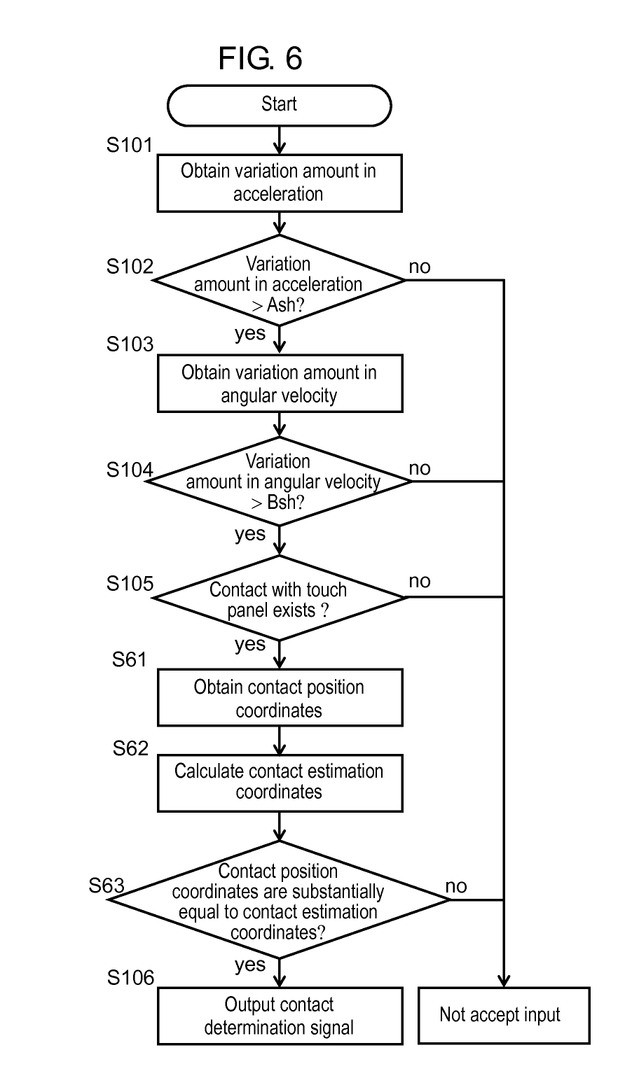

Next, another configuration of more accurately detecting an input operation is described with reference to FIG. 6. FIG. 6 is a flowchart showing another operation of the electronic apparatus shown in FIG. 1. S101 to S106 are the same as those in FIG. 3. Steps different from those in FIG. 3 are described hereinafter.

Touch panel 4 generally detects a contact position on operation surface 4A. In S61, controller 7 acquires information of the contact position at which a finger or the like touches touch panel 4. Here, the information of the contact position is the contact position coordinates in the X-Y coordinates shown in FIG. 2. Thus, by using the angular velocity of electronic apparatus 3A caused by contact of a finger in addition to the output from touch panel 4, controller 7 can estimate the position coordinates at which the contact detection signal is detected. The coordinates estimated using the angular velocity are hereinafter referred to as “contact estimation coordinates”.

Controller 7 calculates the contact estimation coordinates (in S62) based on the variation amount in angular velocity obtained in S103. Controller 7 compares the contact estimation coordinates with the contact position coordinates obtained by the output from touch panel 4 (S63). When the contact estimation coordinates are substantially equal to the contact position coordinates (Yes in S63), controller 7 outputs the contact detection signal as the contact determination signal to application section 11. When the contact estimation coordinates are not equal to the contact position coordinates, controller 7 does not accept the input signal.

This configuration enables more accurate input determination. More specifically, an angular velocity signal around the Y axis is defined as X1, a maximum value in a detection region of the angular velocity signal around the Y axis is defined as X2, an angular velocity signal around the X axis is defined as Y1, and a maximum value in a detection region of the angular velocity signal around the X axis is defined as Y2. Here, each of maximum values X2 and Y2 shows the maximum of the absolute value capable of being taken by each angular velocity signal output from angular velocity detector 6. For example, when the resolution of the angular velocity detector for measuring angular velocity signal X1 around the Y axis is −5000 to 5000, the maximum of the absolute value is 5000 on both the positive side and negative side. Therefore, maximum value X2 is 5000. Using these values, contact estimation coordinates (X, Y) are calculated based on the following equations:

$$\begin{matrix}X = \frac{X 1}{\vert X 2 \vert} \\ where , - \vert X 2 \vert \leq X 1 \leq \vert X 2 \vert , \\ and & ( 2 ) \\ Y = \frac{Y 1}{\vert Y 2 \vert} \\ where , \\ - \vert Y 2 \vert \leq Y 1 \leq \vert Y 2 \vert . & ( 3 )\end{matrix}$$

According to the above-mentioned definitions, it is obvious that −1≦X≦1 and −1≦Y≦1. Therefore, X and Y can be used as position coordinates for estimating the contact position.

The following operation may be employed: the resolution of angular velocity detector 6 is not set as the maximum value in the detection region, but the range of the values obtained when a touch contact with touch panel 4 is actually performed in a normal use condition is determined experimentally and the range value is used.

Thanks to the above-mentioned configuration, the reliability of the input operation determination can be improved from the viewpoint of the position coordinates, and accurate input determination can be achieved.

The contact estimation coordinates may be determined as the input operation position without comparing the contact position coordinates with the contact estimation coordinates. In this configuration, when an input to touch panel 4 is performed with a nail or glove that cannot operate an electrostatic capacitive touch panel, controller 7 can determine the input position.

The contact estimation coordinates can be detected solely based on the angular velocity, so that an input operation may be determined without using acceleration detector 5. In this case, S101 and S102 are not required. Alternatively, an input operation may be determined in only S63 while S104 is omitted.

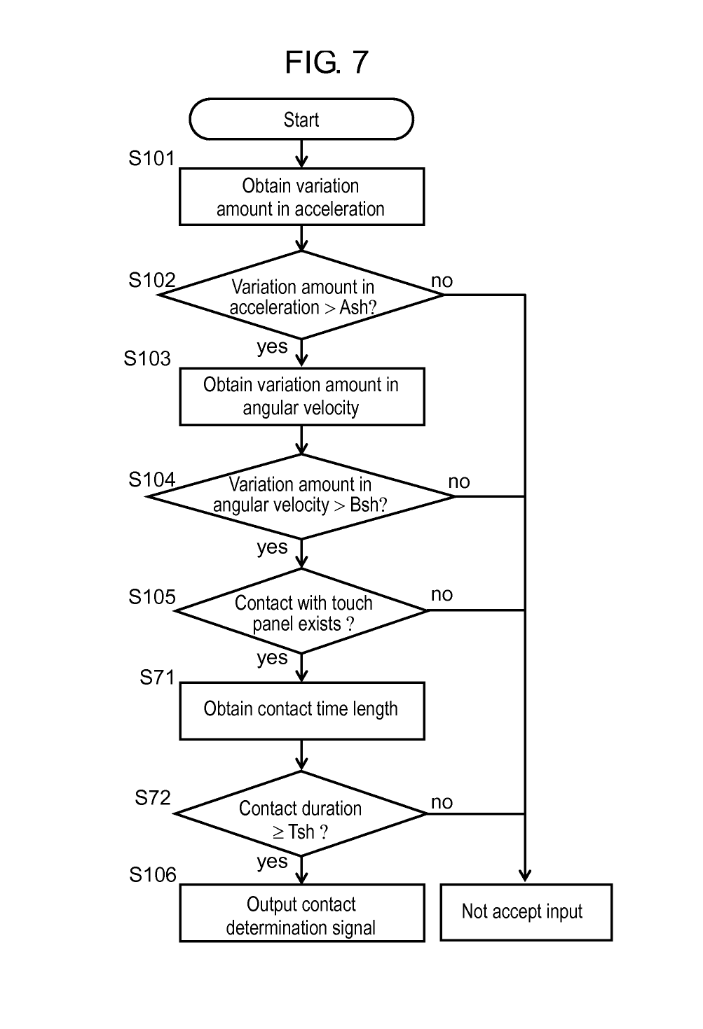

Next, another configuration of more accurately detecting an input operation is described with reference to FIG. 7. FIG. 7 is a flowchart showing another operation of the electronic apparatus shown in FIG. 1. S101 to S106 are the same as those in FIG. 3. Steps different from those in FIG. 3 are described hereinafter.

When an input to touch panel 4 is performed, the time length (period in which a contact detection signal is continued to be detected) from the beginning to the end of a finger pressing action depends on the pressing manner. For example, when touch panel 4 is pressed slowly, the time length of detection of the contact detection signal is long. Also when an operation of intentionally lightly bringing a finger or the like into contact with touch panel 4 and then pressing touch panel 4 is performed, the time length of occurrence of the contact detection signal is long.

Therefore, in order to determine whether or not the contact detection signal detected by touch panel 4 is caused by a finger pressing action, controller 7 obtains the length of time when a finger or the like is in contact with touch panel 4 in S71. Then, controller 7 determines whether or not the time length of occurrence of the contact detection signal is predetermined threshold Tsh or longer (S72). Thus, the addition of the determination reference can increase the determination accuracy of an input operation.

For example, threshold Tsh is set at 0.3 sec, longer than the period (duration) of a normal touch. Based on the threshold, a touch by unintended contact or a light touch can be determined to be a finger pressing action because its contact duration is short.

Also when touch panel 4 is scanned with a finger, the contact duration is long. In such a case, however, the variation of the contact position coordinates is large. While, in the pressing state by a finger pressing action, the variation of the contact position coordinates is small. Therefore, in order to prevent an operation of scanning touch panel 4 with a finger from being determined as an input operation, whether or not the variation of the contact position coordinates is larger than a threshold may be determined after S72.

When an input to touch panel 4 is performed, the time length (period) from the beginning of a finger pressing action to the occurrence of the acceleration and angular velocity caused by the finger pressing action depends on the pressing manner. For example, when touch panel 4 is pressed slowly, the period from the occurrence of the contact detection signal to the occurrence of the acceleration and angular velocity is long. Also when an operation of intentionally lightly bringing a finger or the like into contact with touch panel 4 and then pressing touch panel 4 is performed, the time length from the occurrence of the contact detection signal to the occurrence of the acceleration and angular velocity is long.

In other words, it is assumed that the time at which a contact detection signal is detected is contact time t0, and the time at which acceleration and angular velocity are caused by the finger pressing action is impact detection time t1. Difference period Δt between contact time t0 and impact detection time t1 corresponds to the period after a touch determined to be a finger pressing action is performed at the position coordinates until electronic apparatus 3A is moved actually. Difference time Δt depends on the pressing manner.

Therefore, based on difference period Δt, the processing of electronic apparatus 3A can be changed. For example, difference time Δt can be applied to an operation such as enlargement or reduction of a map or photograph when viewed. More specifically, the ratio of the enlargement or reduction may be changed in response to the length of difference period Δt. Alternatively, the following configuration may be employed: difference period Δt is used to the strength of a feedback when a finger pressing action is performed. For example, the vibration of a vibrator or the like is decreased when difference period Δt is short, and the vibration of the vibrator or the like is increased when difference period Δt is long. Thanks to this configuration, a feedback matching with user's feeling about the strength of a touch can be achieved, and the operability of electronic apparatus 3A can be improved.

When touch panel 4 is of an electrostatic capacitive type and a user touches it with a nail or glove, variation in capacitance ΔC used for detecting a finger pressing action is small and is hardly detected. Also when the user touches the touch panel with a nail or glove, however, acceleration and angular velocity vary. Here, the variation in acceleration is detected by acceleration detector 5, and the variation in angular velocity is detected by angular velocity detector 6. Therefore, an input operation can be detected based on the variations.

More specifically, when the variation amount in acceleration obtained from acceleration detector 5 and the variation amount in angular velocity obtained from angular velocity detector 6 exceed predetermined respective thresholds, the threshold for variation in capacitance ΔC used for detection of touch panel 4 is decreased. This configuration can prevent a malfunction in normal times from being caused by a low threshold of variation in capacitance ΔC when a finger pressing action on touch panel 4 is detected. In other words, a finger pressing action with a nail or glove can be detected accurately.

Instead of decreasing the threshold of touch detection of electrostatic capacitive touch panel 4, a method of increasing the electric field strength, such as a method of coupling the electrodes of touch panel 4 together, may be used to determine an input operation. In this configuration, a malfunction caused by making an electric field strength always high can be prevented, and the electrodes can be coupled together only in a required part when the variation amount in acceleration obtained from acceleration detector 5 and the variation amount in angular velocity obtained from angular velocity detector 6 exceed predetermined thresholds. Therefore, power consumption can be reduced.

### Second Exemplary Embodiment

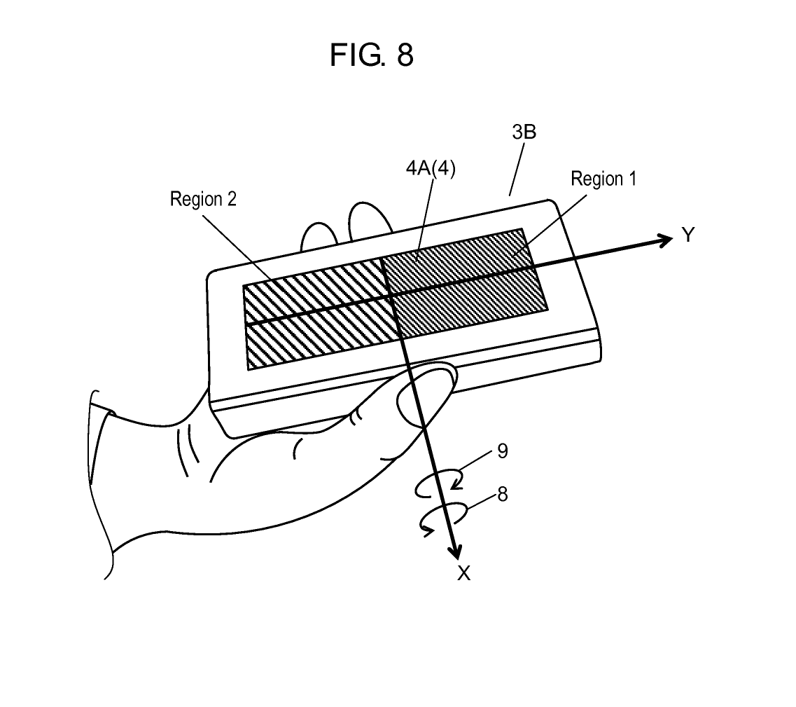

Characterizing parts of electronic apparatus 3B of the second exemplary embodiment of the present invention, mainly the differences from electronic apparatus 3A of the first exemplary embodiment, are described hereinafter with reference to FIG. 8. FIG. 8 is a perspective view of electronic apparatus 3B. Basically, the configuration of electronic apparatus 3B is the same as that shown in FIG. 1.

In other words, touch panel 4 detects that a finger or a thumb comes into contact with operation surface 4A, and outputs a contact detection signal to controller 7. Acceleration detector 5 detects the acceleration of electronic apparatus 3B, and outputs an acceleration signal related to the detected acceleration to controller 7. Angular velocity detector 6 detects the angular velocity of electronic apparatus 3B, and outputs an angular velocity signal related to the detected angular velocity to controller 7.

When controller 7 receives the contact detection signal from touch panel 4, controller 7 determines whether or not the contact of the finger is an input operation based on the measurement results of acceleration and angular velocity. When the contact is determined to be an input operation, controller 7 outputs the contact detection signal as a contact determination signal to application section 11. The operation in the second exemplary embodiment differs from that in the first exemplary embodiment in that the input determination of the contact detection signal is performed based on the rotation direction of the angular velocity at the time when the contact occurs.

Next, one example of the input determination method of electronic apparatus 3B is described. In FIG. 8, arrow 8 shows the rotation direction when electronic apparatus 3B rotates clockwise toward the positive direction of the X axis. Arrow 9 shows the rotation direction when electronic apparatus 3B rotates counterclockwise toward the positive direction of the X axis. Similarly, the rotation directions of the rotation around other axes are defined.

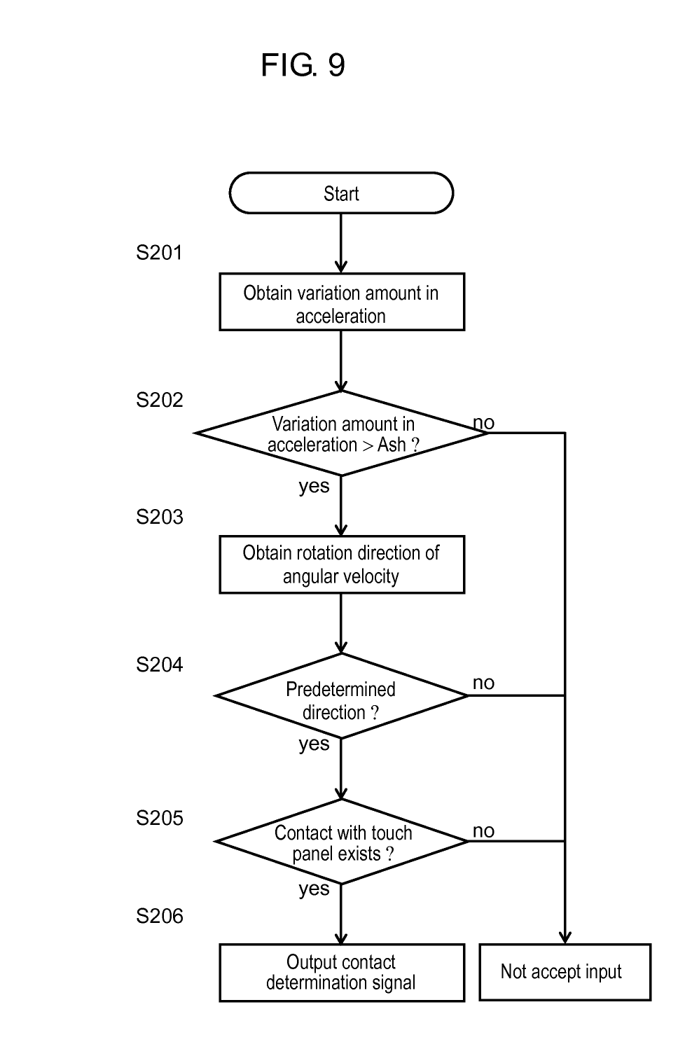

FIG. 9 is a flowchart showing an operation of electronic apparatus 3B. S201, S201, and S205 are the same as S101, S102, and S105 described in the first exemplary embodiment, and the descriptions thereof are omitted.

In S203, controller 7 obtains the rotation direction of the angular velocity of electronic apparatus 3B. The rotation direction is obtained based on the polarity of the detected angular velocity. With reference to FIG. 4B, the angular velocity is negative at point Q2 at which the angular velocity takes an extreme value. Here, the polarity of the angular velocity corresponds to the rotation direction of electronic apparatus 3B, so that the rotation direction can be obtained based on the information related to the polarity. In other words, the rotation direction can be detected simultaneously with detection of the magnitude of the angular velocity.

In S204, controller 7 determines whether or not the rotation direction of the angular velocity calculated in S203 is a predetermined rotation direction. When it is the predetermined rotation direction, the process goes to S205. When it is not the predetermined rotation direction, controller 7 determines the input of the angular velocity to be ineffective and does not accept the input.

Here, the predetermined rotation direction means a counterclockwise rotation direction (arrow 9) toward the positive direction of the X axis when the Y coordinate (value along of the Y axis) of the contact detection signal is positive (namely, when input to region 1 of FIG. 8 is performed). The predetermined rotation direction means a clockwise rotation direction (arrow 8) toward the positive direction of the X axis when the Y coordinate of the contact detection signal is negative (namely, when input to region 2 of FIG. 8 is performed).

Thus, also in electronic apparatus 3B, controller 7 determines whether or not a contact of a finger is an input operation, based on the contact detection signal from touch panel 4, the acceleration signal from acceleration detector 5, and the angular velocity signal from angular velocity detector 6. Therefore, a false input by unintended contact with touch panel 4 can be prevented, and input accuracy can be improved. An input with a small-area by a tool or a nail can be accepted.

The magnitude of the angular velocity detected by angular velocity detector 6 can be affected by movement of a hand that grasps electronic apparatus 3B and by a turn of a travelling vehicle. Even in those cases, the polarity of the angular velocity detected by a finger pressing action is hardly affected by them, and the finger pressing action can be accurately determined. Therefore, the input accuracy can be improved.

The determination may be performed based on an angular velocity differential value obtained by time-differentiating the angular velocity. In this case, a finger pressing action can be accurately determined even when the angular velocity is significantly varied by a turn or the like of a vehicle. Therefore, the input accuracy can be further improved.

In the above-mentioned description, a configuration has been described where it is determined whether or not the input by a contact of a finger is effective by comparing the sign of the Y coordinate of the contact detection signal with the rotation direction of the angular velocity detected around the X axis. Alternatively, the sign of the X coordinate of the contact detection signal may be compared with the rotation direction of the angular velocity detected around the Y axis. In this case, when the rotation direction of the angular velocity matches with the rotation direction of electronic apparatus 3B estimated based on the contact position of a finger, the contact is determined as an effective input operation.

In this configuration, controller 7 outputs the contact detection signal as a contact determination signal in the following two cases:
the value along the X axis of the contact detection signal is positive, and the angular velocity indicated by the angular velocity signal is counterclockwise toward the positive direction of the Y axis; and
the value along the X axis of the contact detection signal is negative, and the angular velocity indicated by the angular velocity signal is clockwise toward the positive direction of the Y axis.

In this control, an emphasized axis can be changed in response to the shape of electronic apparatus 3B and/or the operation manner of the user, and the determination accuracy can be further improved.

A combination of a method of performing determination using the angular velocity around the X axis and a method of performing determination using the angular velocity around the Y axis may be employed. In this case, the determination can be performed based on the acceleration along a plurality of axes and angular velocity around the plurality of axes, and hence the determination accuracy can be further improved.

Similarly to the first exemplary embodiment, S205 may be executed prior to S201. In this case, in S201, controller 7 detects the variation in acceleration between before and after it receives the contact detection signal. In S203, controller 7 obtains the rotation direction of the angular velocity immediately after it receives the contact detection signal. Thus, the calculation amount of controller 7 can be reduced.

### Third Exemplary Embodiment

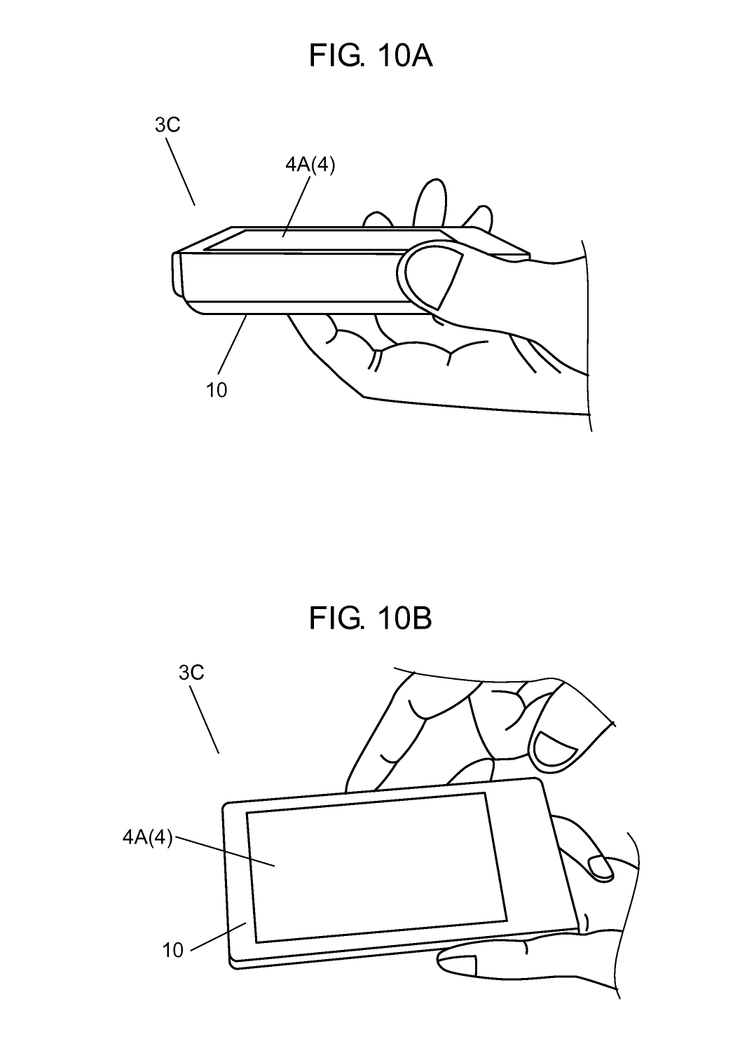

Characterizing parts of electronic apparatus 3C of the third exemplary embodiment of the present invention, mainly the differences from electronic apparatus 3A of the first exemplary embodiment, are described hereinafter with reference to FIG. 10A and FIG. 10B. FIG. 10A and FIG. 10B are perspective views of electronic apparatus 3C. Basically, the configuration of electronic apparatus 3C is the same as that shown in FIG. 1.

In other words, touch panel 4 detects that a finger or a thumb comes into contact with operation surface 4A, and outputs a contact detection signal to controller 7. Acceleration detector 5 detects the acceleration of electronic apparatus 3C, and outputs an acceleration signal related to the detected acceleration to controller 7. Angular velocity detector 6 detects the angular velocity of electronic apparatus 3C, and outputs an angular velocity signal related to the detected angular velocity to controller 7.

When controller 7 receives the contact detection signal from touch panel 4, controller 7 determines whether or not the contact of the finger is an input operation based on the measurement results of acceleration and angular velocity. When the contact is determined to be an input operation, controller 7 outputs the contact detection signal as a contact determination signal to application section 11.

Electronic apparatus 3C includes casing 10 that supports touch panel 4. Controller 7 acquires information of the variation amount in acceleration, the direction of the acceleration, and the rotation direction of the angular velocity in electronic apparatus 3C. When a contact detection signal is not input from touch panel 4, based on the information, controller 7 determines whether or not the detected acceleration and angular velocity are caused by a user's finger pressing action to casing 10 of electronic apparatus 3C. When controller 7 determines that they are caused by the finger pressing action, controller 7 determines that an input to a predetermined surface of casing 10 is performed and outputs an input determination signal.

The operation in the third exemplary embodiment differs from that in the first exemplary embodiment in that, when any contact with touch panel 4 does not occur, input determination is performed based on the acceleration and angular velocity. In other words, when a contact detection signal is not input, an acceleration signal and an angular velocity signal are input, controller 7 determines that an input operation to casing 10 is performed, and outputs the input determination signal to application section 11.

In this configuration, when a finger comes into contact with casing 10 as a part other than touch panel 4 and intends an input, the contact can be determined to be an input operation. Therefore, a finger pressing action shown in FIG. 10A where a finger of the hand that grasps electronic apparatus 3C presses the rear surface of casing 10 can be detected, and a finger pressing action shown in FIG. 10B where a finger presses a side surface of casing 10 can be detected. In other words, electronic apparatus 3C can accept an input to the surface that does not have a sensor for detecting contact, and the operability of electronic apparatus 3C can be improved.

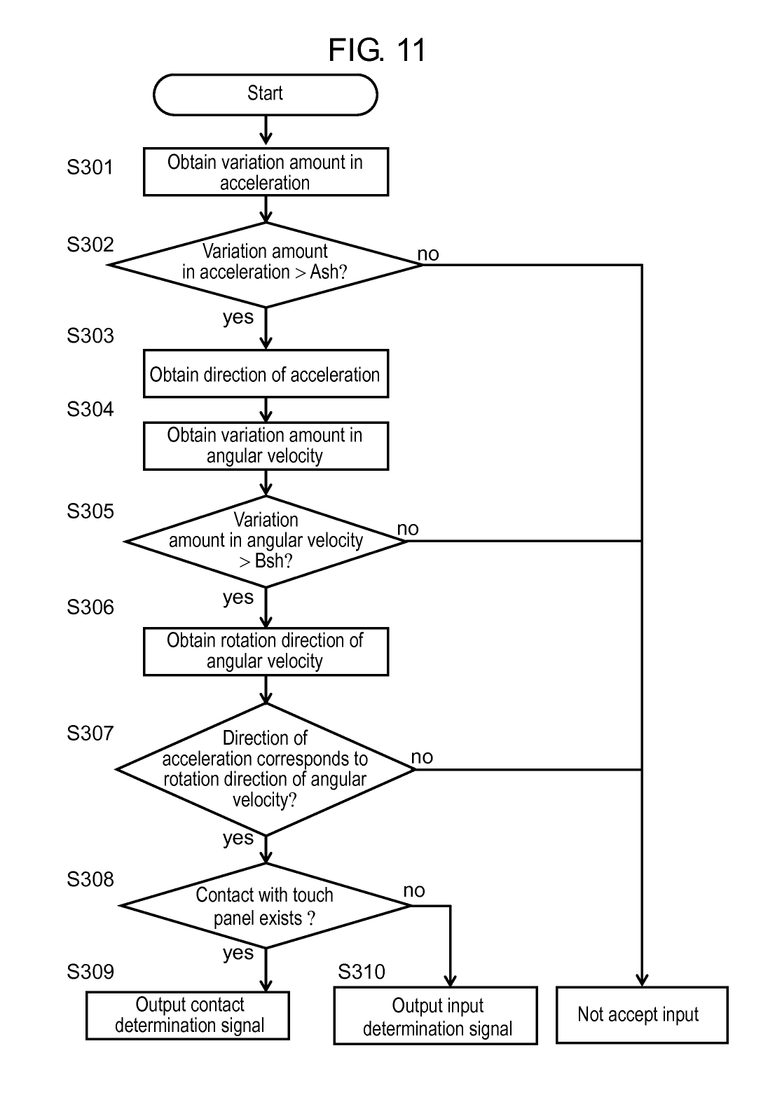

Next, one example of the input determination method is described with reference to FIG. 11. FIG. 11 is a flowchart showing an operation of electronic apparatus 3C. In FIG. 10A and FIG. 10B, similarly to FIG. 2 of the first exemplary embodiment, it is assumed that the longitudinal direction of electronic apparatus 3C is Y axis, the lateral direction is X axis, and the direction perpendicular to the X-Y plane formed of the X axis and Y axis is Z axis.

S301, S302, S304, S305, and S308 are the same as S101, S102, S103, S104, and S105 in FIG. 3, respectively, and S306 is the same as S203 in FIG. 9. Specifically, in S302, controller 7 determines whether or not the variation amount in acceleration calculated in S301 exceeds predetermined threshold Ash. When it exceeds the threshold, the process goes to S303. When it does not exceed the threshold, controller 7 determines the input of the acceleration signal to be ineffective and does not accept the input. The other descriptions are omitted.

In S303, controller 7 obtains the direction of the acceleration of electronic apparatus 3C. The direction of the acceleration is obtained based on the polarity of the detected acceleration. With reference to FIG. 4A, the acceleration is negative at point Q1 at which the acceleration takes an extreme value. Here, the polarity of the acceleration corresponds to the rotation direction of electronic apparatus 3C, so that the direction of the acceleration can be obtained based on the information related to the polarity. In other words, the direction of the acceleration can be detected simultaneously with detection of the magnitude of the acceleration.

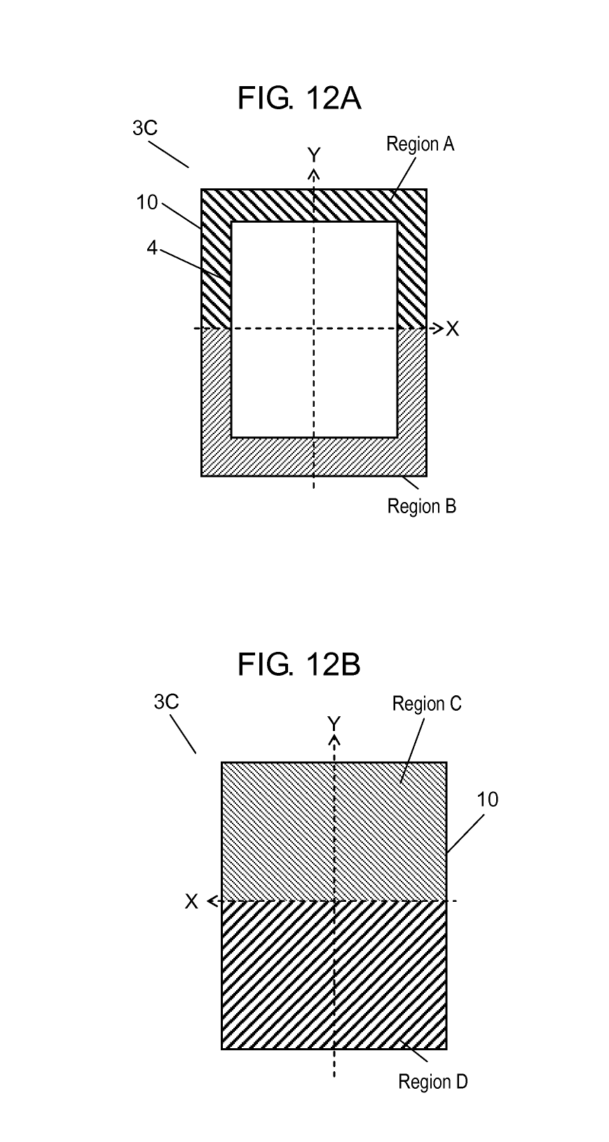

In S307, controller 7 determines the input operation in accordance with the relationship shown in Table 1. Regions A to D in Table 1 are shown in FIG. 12A and FIG. 12B. FIG. 12A and FIG. 12B are a front view and rear view of electronic apparatus 3C, respectively. Region A is a region whose Y coordinate is positive on casing 10 disposed on the same plane as touch panel 4. Region B is a region whose Y coordinate is negative on casing 10 disposed on the same plane as touch panel 4. Region C is a region whose Y coordinate is positive on the rear surface of casing 10. Region D is a region whose Y coordinate is negative on the rear surface of casing 10.

TABLE 1

| | | Direction of angular | |
|---|---|---|---|
| | | velocity toward | |
| Acceleration | | positive direction | Determination |
| Magnitude | Direction | of X axis | result |
| >Ash | Negative direction | Counterclockwise | Input to region A |
| | of Z axis | Clockwise | Input to region B |
| | Positive direction | Clockwise | Input to region C |
| | of Z axis | Counterclockwise | Input to region D |
| ≦Ash | — | — | No input |

As shown in Table 1, when the acceleration is in the negative direction of the Z axis and the angular velocity is counterclockwise toward the positive direction of the X axis, controller 7 determines that the detected acceleration and angular velocity indicate a finger pressing action to region A. When the acceleration is in the negative direction of the Z axis and the angular velocity is clockwise toward the positive direction of the X axis, controller 7 determines that the detected acceleration and angular velocity indicate a finger pressing action to region B.

When the acceleration is in the positive direction of the Z axis and the angular velocity is clockwise toward the positive direction of the X axis, controller 7 determines that the detected acceleration and angular velocity indicate a finger pressing action to region C. When the acceleration is in the positive direction of the Z axis and the angular velocity is counterclockwise toward the positive direction of the X axis, controller 7 determines that the detected acceleration and angular velocity indicate a finger pressing action to region D.

When any contact with touch panel 4 does not occur (No in S308), in S310, controller 7 outputs, to application section 11, an input determination signal as information that indicates an input to the region determined in S307.

When the direction of acceleration and the direction of angular velocity are not included in the above-mentioned combinations, controller 7 determines that the input of the acceleration and angular velocity is ineffective (No in S307). In this case, controller 7 does not send the input determination signal to application section 11. In other words, when this contact occurs, application section 11 does not execute processing.

When contact with touch panel 4 occurs (Yes in S308), similarly to S106 in FIG. 3, controller 7 determines the contact detection signal output from touch panel 4 to be effective and outputs it as a contact determination signal to application section 11 (S309).

Thus, controller 7 of electronic apparatus 3C determines whether or not the input by the contact of a finger is effective based on the acceleration from acceleration detector 5 and the angular velocity from angular velocity detector 6. Therefore, for example, a finger pressing action to the rear surface or a side surface of casing 10 can be set as a target of input determination. In other words, an input to a part other than touch panel 4 can be detected, so that the operability of electronic apparatus 3C can be improved. Furthermore, an input to the rear surface of electronic apparatus 3C can be performed with the hand that grasps electronic apparatus 3C, for example. Therefore, electronic apparatus 3C can be operated with one hand, and the operability can be improved.

As shown in Table 1, controller 7 can determine which of region A to region D has undergone an input operation. When controller 7 outputs different input determination signals correspondingly to the respective cases, application section 11 can perform different operations. Thus, it is preferable that controller 7 determines the position of an input operation to casing 10 based on the direction and magnitude of the acceleration indicated by the acceleration signal and the rotation direction of the angular velocity indicated by the angular velocity signal.

The above-mentioned description has shown the following method: among region A to region D on the front surface and rear surface of electronic apparatus 3C, which region has undergone an input operation is determined based on the direction of the acceleration in the Z axis direction and the rotation direction of the angular velocity around the X axis. Similarly to this, determination may be performed based on the variation amount in acceleration in the Z axis direction and the rotation direction of the angular velocity around the Y axis.

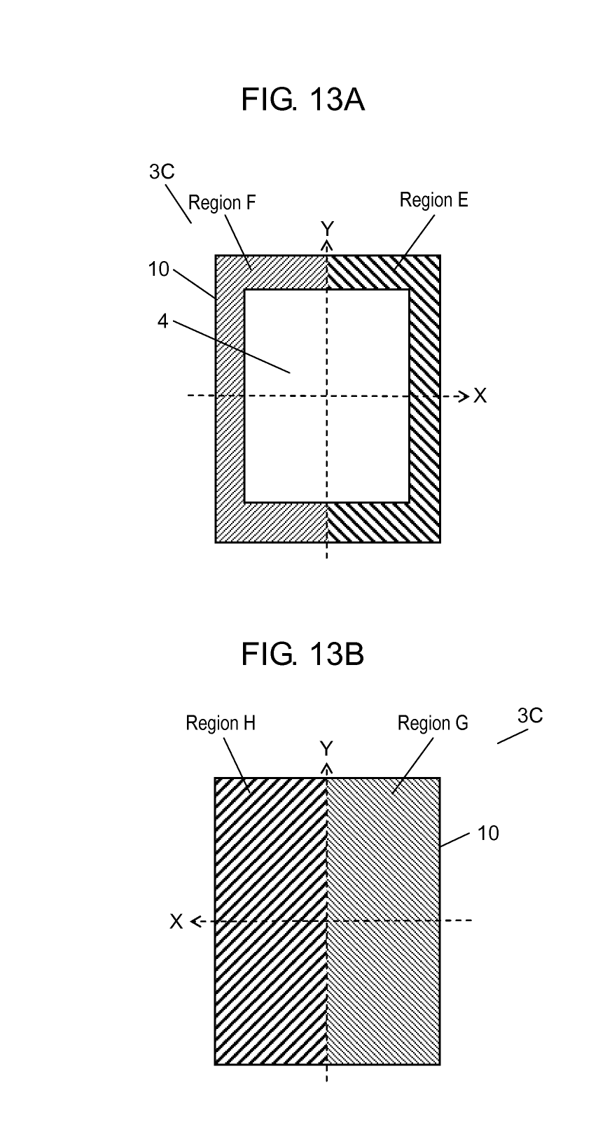

In this configuration, as shown in FIG. 13A and FIG. 13B, an input to region E to region H can be detected. FIG. 13A and FIG. 13B are a front view and rear view of electronic apparatus 3C. Region E is a region whose X coordinate is positive on casing 10 disposed on the same plane as touch panel 4. Region F is a region whose X coordinate is negative on casing 10 disposed on the same plane as touch panel 4. Region G is a region whose X coordinate is negative on the rear surface of casing 10. Region H is a region whose X coordinate is positive on the rear surface of casing 10. Also in this case, the operability can be improved.

By appropriately selecting one of the case where the rotation direction of the angular velocity around the X axis is used for determination and the case where the rotation direction of the angular velocity around the Y axis is used for determination, the emphasized region can be changed in response to the shape of the electronic apparatus or an operation manner by the user. Therefore, the determination accuracy can be further improved.

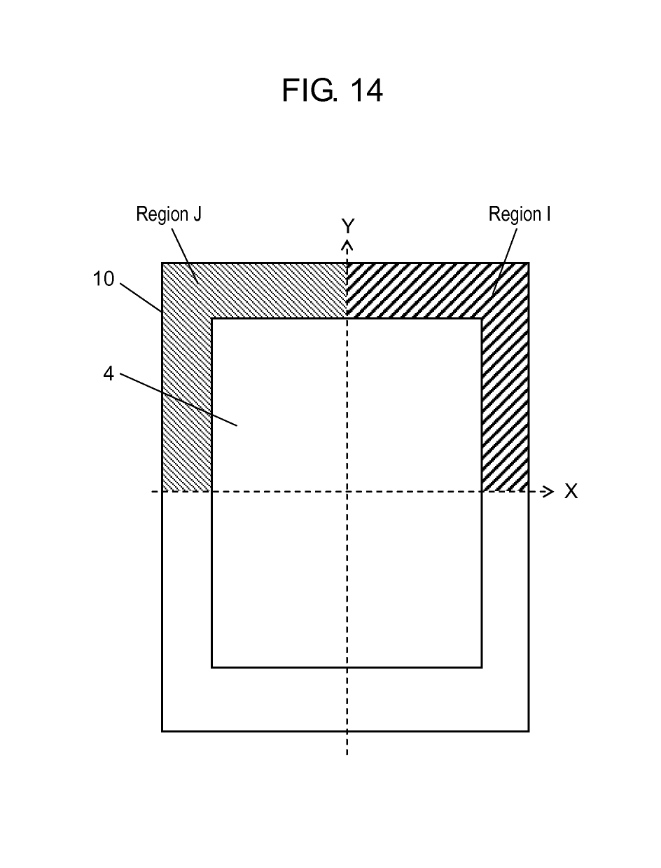

By employing a combination of these cases, an input to region I and region J can be detected as shown in FIG. 14, for example, and hence the determination accuracy can be further improved.

The determination may be performed based on the direction of the acceleration in the X axis direction or Y axis direction and the rotation direction of the angular velocity around the Z axis. In this configuration, an input to a side surface of casing 10 can be detected, and hence the operability can be further improved.

The above-mentioned description has shown the case where the determination of an input operation to casing 10 is combined with the configuration of the first exemplary embodiment. However, the determination of an input operation to casing 10 may be combined with the configuration as the base of the second exemplary embodiment. In other words, a characteristic point of the third exemplary embodiment is that, when a contact detection signal is not input, an acceleration signal and an angular velocity signal are input, the controller determines that an input operation to the casing is performed and outputs an input determination signal. Therefore, controller 7 outputs a contact determination signal based on the contact detection signal, acceleration signal, and angular velocity signal. As an example, when an acceleration signal and an angular velocity signal are input, the controller may output a contact detection signal as the contact determination signal.

Thus, the first exemplary embodiment has described the configuration where input determination is performed based on the variation amount in acceleration and the variation amount in angular velocity. The second exemplary embodiment has described the configuration where input determination is performed based on the variation amount in acceleration and the direction of angular velocity. The third exemplary embodiment has described the configuration where input determination is performed based on the variation amount in acceleration, the direction of acceleration, and the direction of angular velocity. These configurations are not limited to be used independently and may be combined with each other for determination.

The control described with reference to FIG. 5 to FIG. 7 may be applied to the second exemplary embodiment and third exemplary embodiment.

### Fourth Exemplary Embodiment

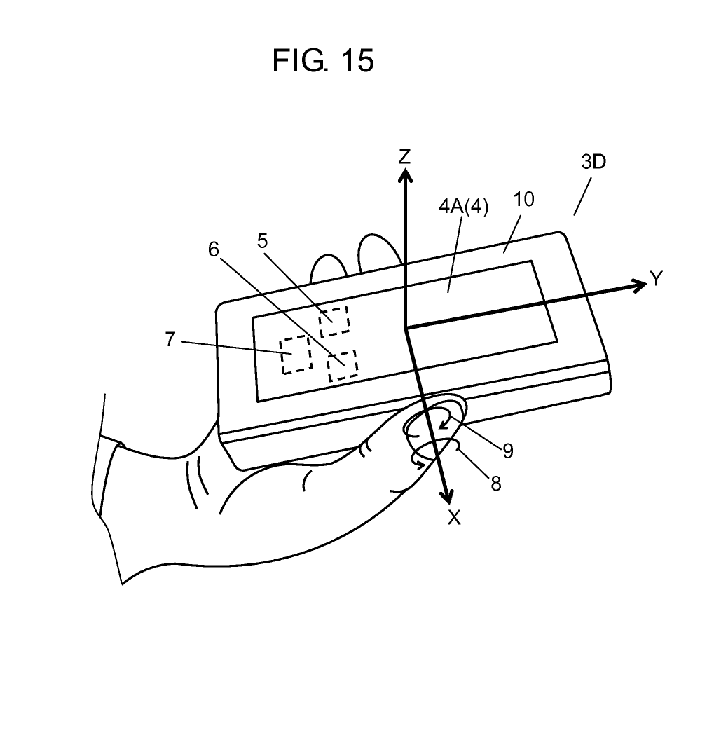

Characterizing parts of electronic apparatus 3D of the fourth exemplary embodiment of the present invention, mainly the differences from electronic apparatus 3A of the first exemplary embodiment, are described hereinafter with reference to FIG. 15 to FIG. 18B. FIG. 15 is a perspective view of electronic apparatus 3D. The configuration of electronic apparatus 3D is basically the same as that shown in FIG. 1.

In other words, touch panel 4 detects that a finger or a thumb comes into contact with operation surface 4A, and outputs a contact detection signal to controller 7. Acceleration detector 5 detects the acceleration of electronic apparatus 3B, and outputs an acceleration signal related to the detected acceleration to controller 7. Angular velocity detector 6 detects the angular velocity of electronic apparatus 3D, and outputs an angular velocity signal related to the detected angular velocity to controller 7.

In electronic apparatus 3D, controller 7 performs first processing or second processing based on the contact detection signal, the acceleration signal, and the angular velocity signal. Specifically, controller 7 performs the first processing when a contact detection signal is input from touch panel 4, and an acceleration signal is not input from acceleration detector 5 or an angular velocity signal is not input from angular velocity detector 6. Controller 7 performs the second processing when a contact detection signal is input from touch panel 4, an acceleration signal is input from acceleration detector 5, and an angular velocity signal is input from angular velocity detector 6.

Recently, in an electronic apparatus such as a portable terminal, the screen has been enlarged and the thickness has been decreased. Following this trend, tempered glass is disposed on the surface of the electronic apparatus. As a result, the rigidity of the electronic apparatus is increased, and hence a conventional electronic apparatus is difficult to measure the pressing force.

However, thanks to the configuration of electronic apparatus 3D, electronic apparatus 3D can recognize a finger pressing action even when a rigid structure or material is employed. A measuring section for detecting the pressing force does not need to be prepared separately, so that the cost can be reduced and the required space can be reduced. Furthermore, by combining touch panel 4, acceleration detector 5, and angular velocity detector 6 together, accurate input determination can be achieved.

As shown in FIG. 15, when the surface of electronic apparatus 3D on which operation surface 4A is disposed is substantially rectangular, it is assumed that the longitudinal direction is Y axis, the lateral direction is X axis, the direction perpendicular to the X-Y plane formed of the X axis and Y axis is Z axis, and an approximate center of touch panel 4 is an origin. Here, arrow 8 shows the rotation direction when electronic apparatus 3D rotates clockwise toward the positive direction of the X axis. Arrow 9 shows the rotation direction when electronic apparatus 3D rotates counterclockwise toward the positive direction of the X axis.

Acceleration detector 5 detects an acceleration of electronic apparatus 3D in a predetermined direction, and sends an acceleration signal as information related to the detected acceleration to controller 7. Here, the predetermined direction means a direction in which variation in acceleration of electronic apparatus 3D caused by the finger pressing action to touch panel 4 can be detected. Similarly to the first exemplary embodiment, the variation in acceleration of electronic apparatus 3D caused by the finger pressing action to touch panel 4 is detected mainly as the acceleration of electronic apparatus 3D in the Z axis direction. Therefore, in order to detect the acceleration of electronic apparatus 3D, an acceleration sensor capable of detecting the acceleration of electronic apparatus 3D in the Z axis direction is used for acceleration detector 5.

Angular velocity detector 6 detects the angular velocity of electronic apparatus 3D around the X axis and Y axis, and sends, to controller 7, an angular velocity signal as information related to the detected angular velocity. In order to detect the angular velocity of electronic apparatus 3D, an angular velocity sensor capable of detecting the angular velocity of electronic apparatus 3D around the X axis and Y axis is used as angular velocity detector 6.

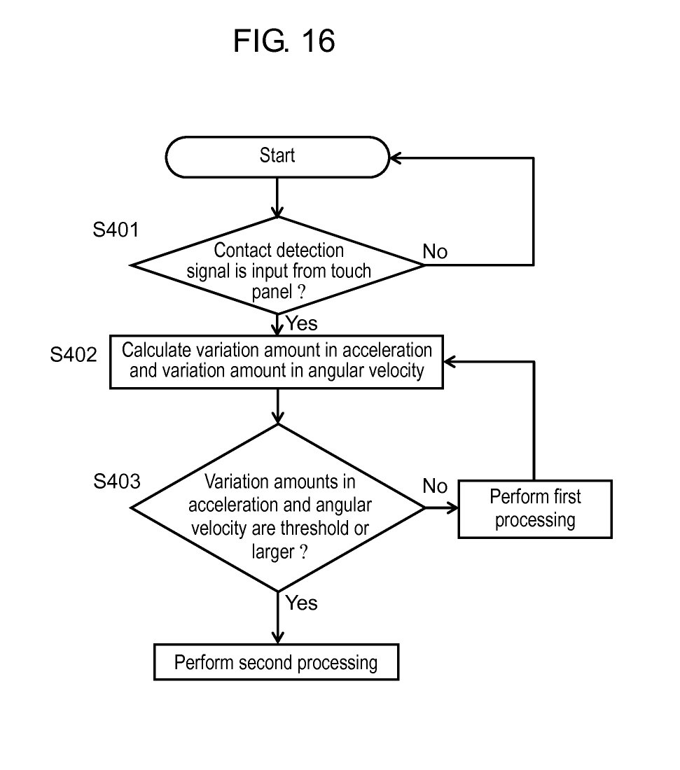

Next, an operation of electronic apparatus 3D is described with reference to FIG. 16. FIG. 16 is a flowchart showing the operation of electronic apparatus 3D.

In S401, controller 7 determines whether or not a contact detection signal is input from touch panel 4. When a contact detection signal is input, the process goes to S402. When a contact detection signal is not input, the process returns to S401.

In S402, controller 7 calculates the variation amount in acceleration based on the acceleration signal input from acceleration detector 5, and calculates the variation amount in angular velocity based on the angular velocity signal input from angular velocity detector 6.

In S403, controller 7 determines whether or not an acceleration signal is input from acceleration detector 5 and an angular velocity signal is input from angular velocity detector 6. Specifically, when the variation amount in acceleration or the variation amount in angular velocity calculated in S402 does not exceed a predetermined range, controller 7 determines that there is not an input in which the variation amount exceeds the predetermined range, and performs the first processing. When the variation amount in acceleration and the variation amount in angular velocity exceed the predetermined range, controller 7 determines that signals are input from acceleration detector 5 and angular velocity detector 6, and performs the second processing.

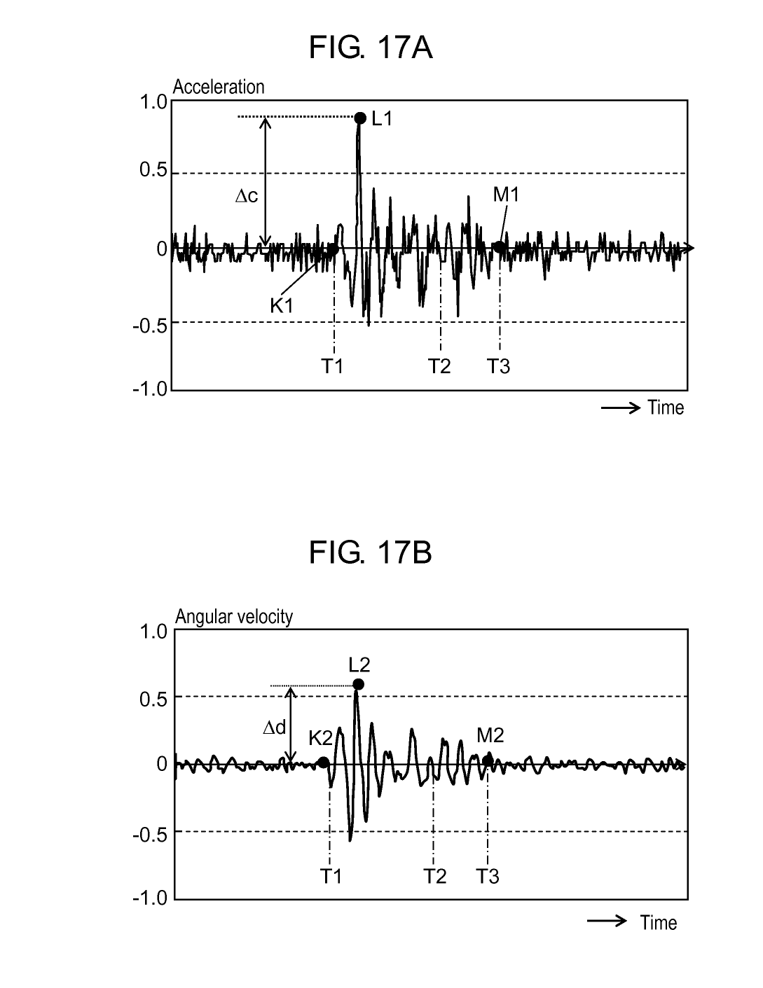

Next, one example of the method for calculating the variation amount in acceleration and the variation amount in angular velocity is described with reference to FIG. 17A and FIG. 17B. FIG. 17A and FIG. 17B show the output waveforms of the acceleration and angular velocity detected when a finger is pressed following a state where the finger is in contact with touch panel 4. The horizontal axes show time, and the vertical axes show the magnitudes of the detected acceleration and angular velocity, respectively.

In FIG. 17A and FIG. 17B, points K1 and K2 show the time at which contact with touch panel 4 occurs. Points L1 and L2 show the times at which the acceleration and angular velocity caused by the contact take extreme values, respectively. Points M1 and M2 show the times at which the output waveforms of the angular velocity caused by a finger pressing action steady down.

Variation amount in angular velocity Δd is obtained by calculating the difference between the average of the angular velocity values immediately before point K2 and the angular velocity value at point L2. In this method, the variation amount can be calculated without being affected by noise or offset of the angular velocity sensor, and hence determination accuracy is improved. Variation amount in acceleration Δc can be calculated similarly to the method of obtaining the variation amount in angular velocity.

Thanks to this configuration, electronic apparatus 3D can recognize a finger pressing action even when a rigid structure or material is employed. A measuring section for detecting the pressing force does not need to be prepared separately, so that the cost can be reduced and the required space can be reduced. Furthermore, controller 7 determines whether or not an input by a finger pressing action is effective based on the contact detection signal from touch panel 4, the acceleration from acceleration detector 5, and the angular velocity from angular velocity detector 6. Therefore, false detection can be reduced even when a finger or the like comes into contact with touch panel 4 without intending an input during an operation of electronic apparatus 3D, for example. Especially, although acceleration has high sensitivity to a touch, touching a position separate from the position of the acceleration sensor may decrease the signal strength thereof. On the other hand, the signal strength of the angular velocity obtained from the angular velocity sensor does not decrease even away from the position of the angular velocity sensor. Therefore, a combined use of the acceleration sensor and angular velocity sensor enables more accurate detection in all regions.

A specific example of the first processing and second processing is the so-called drag and drop operation in an electronic apparatus having an image display function, such as a portable phone, an electronic book, and a tablet terminal. In this case, the first processing is to start dragging, and the second processing is to fix a dragging object, namely an operation part displayed on touch panel 4, to a destination. The operation part is hereinafter referred to as “operation part”.

Another specific example of the first processing and second processing is drawing processing in an electronic apparatus having an image display function, such as a portable phone, an electronic book, and a tablet terminal. In this case, the first processing is to start drawing a diagram such as a line, and the second processing is to change the shape of the diagram or finish the drawing.

In the above-mentioned description, in S403, when the variation amount in acceleration or the variation amount in angular velocity does not exceed a predetermined range, controller 7 determines that there is not an input from the detector where the variation amount does not exceed the predetermined range, and performs the first processing. However, the condition for performing the first processing is not limited to this. In other words, the following configuration may be employed: controller 7 performs the first processing when the variation amount in acceleration does not exceed a predetermined range and the variation amount in angular velocity does not exceed a predetermined range. In other words, controller 7 may perform the first processing when controller 7 determines that there is no input from acceleration detector 5 and angular velocity detector 6.

In the above-mentioned description, in S403, when the variation amounts in acceleration and angular velocity exceed predetermined ranges, respectively, controller 7 determines that there are inputs from acceleration detector 5 and angular velocity detector 6, and performs the second processing. However, the condition for performing the second processing is not limited to this. In other words, the following configuration may be employed: when the variation amount in acceleration or angular velocity exceeds a predetermined range, controller 7 determines that there is an input from the detector where the variation amount exceeds the predetermined range, and performs the second processing.

Alternatively, in S403, when the variation amount in acceleration and the variation amount in angular velocity continue to occur for a predetermined threshold period of time or longer, controller 7 may determine that there are inputs from acceleration detector 5 and angular velocity detector 6, and may perform the second processing in S404. This configuration enables more accurate detection of a finger pressing action. Hereinafter, this point is described specifically.

When a finger pressing action is performed in a state where a finger is in contact with touch panel 4, and hence a contact detection signal is input from touch panel 4, the period of time in which the variations in acceleration and angular velocity occur is characteristically long.

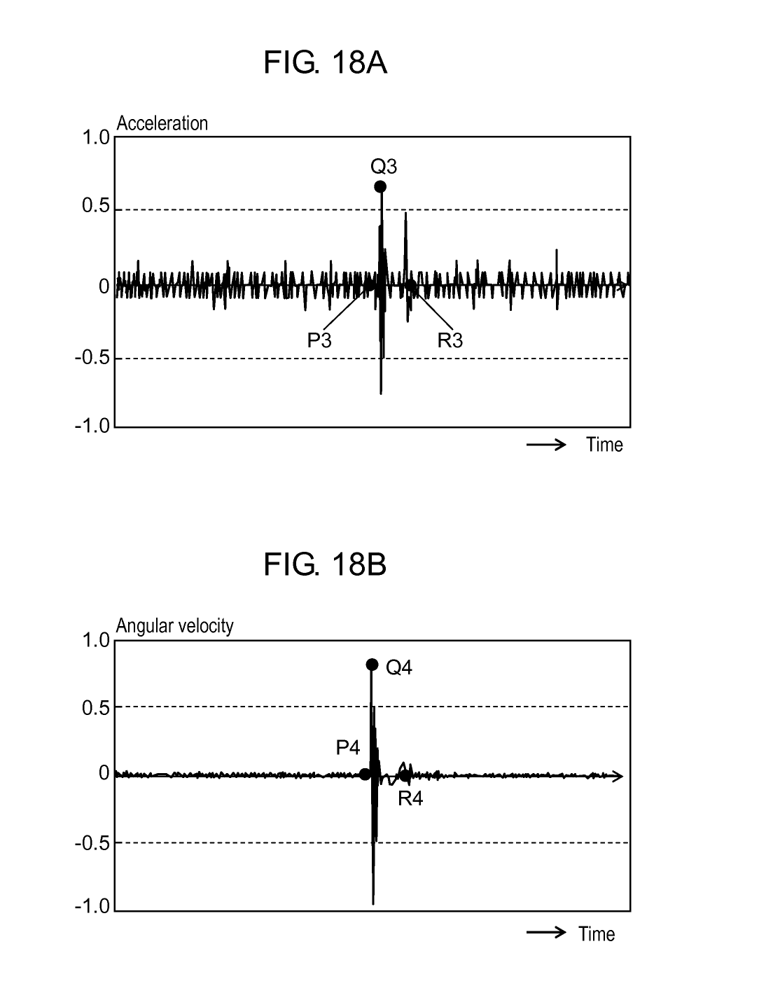

FIG. 18A and FIG. 18B show the output waveforms of typical acceleration and typical angular velocity detected during a normal finger pressing action. Here, the normal finger pressing action means the operation of bringing a finger into contact with operation surface 4A of touch panel 4 to cause an input to touch panel 4. In FIG. 18A and FIG. 18B, points P3 and P4 show the time at which contact with touch panel 4 occurs, points Q3 and Q4 show the times at which the waveforms caused by the contact take extreme values, respectively, and points R3 and R4 show the times at which the output waveforms caused by the contact steady down.

Comparisons between FIG. 17A and FIG. 18A and between FIG. 17B and FIG. 18B clearly shows that the waveforms of the acceleration and angular velocity differ between the action of further pressing touch panel 4 with a finger following the state where the finger is in contact with touch panel 4 and a normal finger pressing action. This point is described in more detail.

Regarding the angular velocity caused by the normal finger pressing action, the period of time from the occurrence to the convergence is that between P4 and R4. Regarding the angular velocity caused by the action of further pressing touch panel 4 with the finger following the state where the finger is in contact with touch panel 4, the period of time from the occurrence to the convergence is that between K2 and M2. The period between P4 and R4 is significantly shorter than the period between K2 and M2. This is considered to be because, a strong force is more slowly applied to electronic apparatus 3D and thus the attitude of electronic apparatus 3D more slowly changes in the finger pressing action than in the normal touch. Also regarding the acceleration, the period of time from the occurrence to the convergence of the waveform is shorter in the normal finger pressing action than in the action of further pressing touch panel 4 with the finger following the state where the finger is in contact with touch panel 4. This point can be understood by comparing FIG. 17A with FIG. 18A.

Therefore, by performing determination based on the periods of time of occurrence of the acceleration and angular velocity, the finger pressing action can be detected more accurately. Especially, although acceleration has high detection sensitivity to contact with electronic apparatus 3D, touching a position separate from the position of the acceleration sensor may decrease the signal strength thereof. On the other hand, the signal strength of the angular velocity signal obtained from the angular velocity sensor does not decrease even away from the position of the angular velocity sensor. Therefore, a combined use of the acceleration sensor and angular velocity sensor enables more accurate detection in all regions. The signal noises in FIG. 18A and FIG. 18B are larger than those in FIG. 4A and FIG. 4B because the sensitivity in FIG. 18A and FIG. 18B is increased. This increase is because it is taken into account that the angular velocity and acceleration caused by the finger pressing action are lower than those caused by the normal touch.

The case where determination is performed based on the periods of time of occurrence of the acceleration and angular velocity has been described, but the present invention is not limited to this. In other words, the following configuration may be employed: predetermined thresholds are set, and determination is performed based on the period of time when the magnitudes of the acceleration and angular velocity are larger than the predetermined thresholds.

The configuration has been described where, in S403, determination is performed based on whether or not the variation amount in acceleration or the variation amount in angular velocity exceeds a threshold. However, determination may be performed based on whether or the absolute value of the acceleration or the absolute value of the angular velocity exceeds a threshold. In this configuration, determination can be performed with a simpler configuration. Furthermore, the calculation amount of controller 7 required for the input determination can be reduced.

The present exemplary embodiment has described the case where an input to touch panel 4 is performed with a finger or a thumb. However, the thing used for input is not limited to a finger or a thumb. For example, a nail or pen may be employed. In this configuration, a tool used for input is not limited, and the operability of electronic apparatus 3D is improved.

When an electrostatic capacitive touch panel is employed, the finger's area may be calculated based on the variation in capacitance, and the calculation result may be collated with the determination result of the finger pressing action, thereby improving the detection accuracy.

The manner of the second processing may be changed in response to the variation amount in acceleration and the variation amount in angular velocity. As a specific example, when the first processing and second processing are related to drawing, the thickness, area, or type of drawing lines may be changed in response to the variation amount in acceleration and the variation amount in angular velocity. More specifically, the attitude of electronic apparatus 3D is changed in response to the pressing force during drawing, and the change can be detected as the variation amounts in acceleration and angular velocity. In this configuration, press down or throw away in a character can be drawn on the touch panel, and the operability of electronic apparatus 3D is improved.

In the above-mentioned description, the input determination is performed based on the waveforms of the acceleration and angular velocity when a finger is pressed. However, the present invention is not limited to this. More specifically, when a finger is separated after the state where the finger is pressed, a phenomenon occurs where electronic apparatus 3D returns by the reaction. In this case, the second processing may be performed based on the variation amount in angular velocity or the variation amount in acceleration at this time. This operation is described more specifically with reference to FIG. 17A and FIG. 17B.

The waveform detected in the period from time T1 to time T2 is caused by the action in which a finger is pressed. The waveform detected in the period from time T2 to time T3 is caused by the action in which a finger is separated after the pressing state of the finger. As shown in FIG. 17A and FIG. 17B, respective waveforms corresponding to pressing of the finger and separation of the finger are produced. Therefore, by using one of the waveform when the finger is pressed and the waveform when the finger is separated, the determination described in FIG. 16 may be performed. Alternatively, the determination described in FIG. 16 may be performed by using both waveforms. In those configurations, more accurate input determination can be achieved. The output waveforms of the acceleration and angular velocity detectable in a finger pressing action vary depending on the user, and the waveform when the finger is separated is sometimes larger than that when the finger is pressed. Even in such a case, however, false detection due to the user dependence can be prevented and the determination accuracy can be improved by using, for the determination, one or both of the waveform when the finger is pressed and the waveform when the finger is separated.

In the above-mentioned description, the determination is performed based on both of the acceleration and angular velocity. However, the present invention is not limited to this. In other words, the determination may be performed based on one of the acceleration and angular velocity. This configuration enables the determination to be achieved with a simple configuration.

### Fifth Exemplary Embodiment

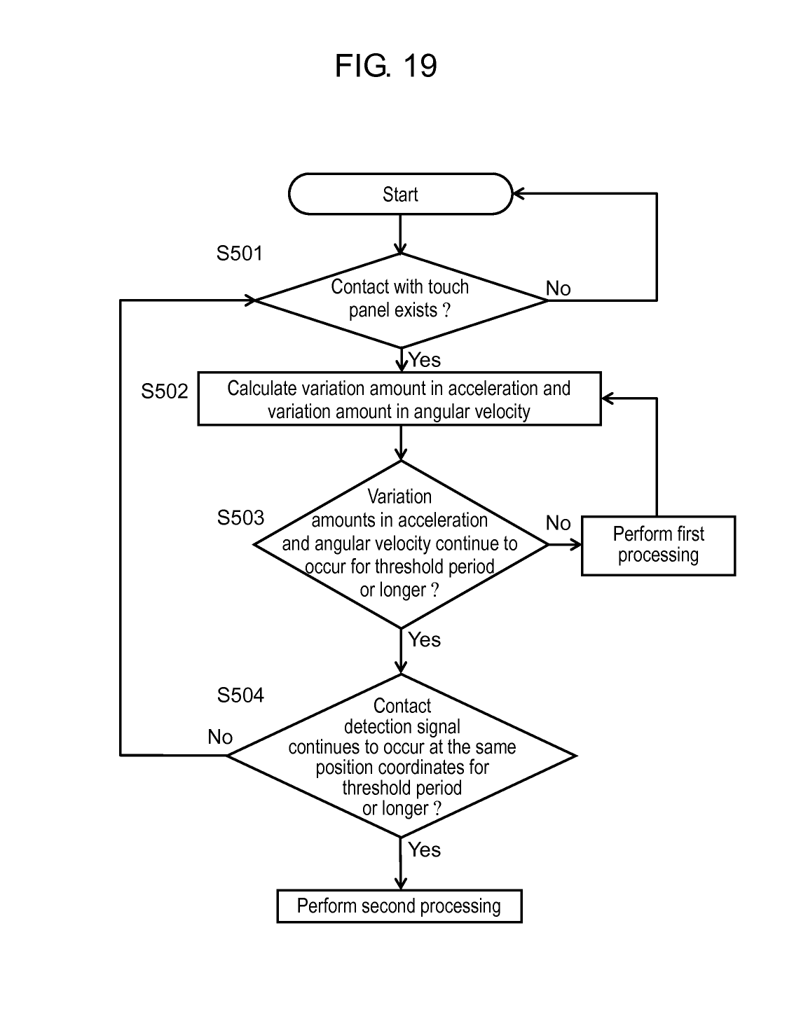

Characterizing parts of electronic apparatus 3E of the fifth exemplary embodiment of the present invention, mainly the differences from electronic apparatus 3D of the fourth exemplary embodiment, are described hereinafter with reference to FIG. 19. The configuration of electronic apparatus 3E is basically the same as that shown in FIG. 1 and FIG. 15.

Similarly to the fourth exemplary embodiment, touch panel 4 detects that a finger or a thumb comes into contact with operation surface 4A, and outputs a contact detection signal to controller 7. Acceleration detector 5 detects the acceleration of electronic apparatus 3E, and outputs the detected acceleration to controller 7. Angular velocity detector 6 detects the angular velocity of electronic apparatus 3E, and outputs the detected angular velocity to controller 7.

The operation in the fifth exemplary embodiment differs from that in the fourth exemplary embodiment in that controller 7 performs input determination based on the variation amount in acceleration, the variation amount in angular velocity, and the detection period of time of a contact detection signal.

FIG. 19 is a flowchart showing an operation of electronic apparatus 3E in accordance with the fifth exemplary embodiment of the present invention. S501 to S503 are the same as S401 to S403 of FIG. 16, and hence the descriptions of them are omitted.

In S504, controller 7 determines whether or not there is an input from touch panel 4. Specifically, controller 7 determines whether or not the contact detection signal at the same coordinate position continues to occur for a predetermined threshold period of time or longer. When the contact detection signal does not continue to occur for the predetermined threshold period of time or longer, controller 7 determines that there is no input from touch panel 4, and the process returns to S501. When the contact detection signal continues to occur for the predetermined threshold time period of or longer, controller 7 determines that there is an input from touch panel 4, and performs the second processing.

Thanks to this configuration, more accurate input determination can be achieved. The time duration from the beginning to the end of the contact is longer in a finger pressing action than in a normal touch. Therefore, the finger pressing action is determined based on whether or not the contact detection signal continues to occur for the predetermined threshold period of time or longer in S504. Thus, more accurate input determination can be achieved.

The configurations described in fourth and fifth exemplary embodiments are not limited to independent use, but a combination of the configurations may be used for determination. By moving the execution of S401 and S501 to be later, the configurations may be combined with those in first to third exemplary embodiments.

### INDUSTRIAL APPLICABILITY

An electronic apparatus of the present invention enables more accurate input determination, and hence is useful as an electronic apparatus such as a portable phone, an electronic book, and a tablet information terminal.

### REFERENCE MARKS IN THE DRAWINGS

3A, 3B, 3C, 3D, 3E electronic apparatus
4 touch panel
4A operation surface
5 acceleration detector
6 angular velocity detector
7 controller
8, 9 arrow
10 casing
11 application section

1. An electronic apparatus comprising:
a touch panel having an operation surface, and configured to detect a contact with the operation surface, and output a contact detection signal;
an acceleration detector configured to detect an acceleration of the electronic apparatus and output an acceleration signal;
an angular velocity detector configured to detect an angular velocity of the electronic apparatus and output an angular velocity signal; and
a controller connected to the touch panel, the acceleration detector, and the angular velocity detector, and operable to output the contact detection signal as a contact determination signal when the acceleration signal is input from the acceleration detector and the angular velocity signal is input from the angular velocity detector.

2. The electronic apparatus according to claim 1, wherein
the controller outputs the contact detection signal as the contact determination signal when a magnitude of an acceleration indicated by the acceleration signal exceeds a predetermined threshold and a magnitude of an angular velocity indicated by the angular velocity signal exceeds a first threshold.

3. The electronic apparatus according to claim 2, wherein
the operation surface of the touch panel has an origin at a center of the touch panel and is disposed on coordinates defined by an X axis and a Y axis orthogonal to each other, and a Z axis perpendicular to the operation surface is defined, and
in a case where a magnitude of an acceleration along the Z axis indicated by the acceleration signal is equal to a gravitational acceleration, the controller outputs the contact detection signal as the contact determination signal when a magnitude of the acceleration indicated by the acceleration signal exceeds the predetermined threshold and a magnitude of the angular velocity indicated by the angular velocity signal exceeds a second threshold smaller than the first threshold.

4. The electronic apparatus according to claim 1, wherein
the operation surface of the touch panel has an origin at a center of the touch panel and is disposed on coordinates defined by an X axis and a Y axis orthogonal to each other,
the touch panel outputs, to the controller, contact position coordinates indicating a position at which the touch panel detects a contact,
the controller estimates contact estimation coordinates indicating a contact position on the touch panel based on the angular velocity signal and acceleration signal, and
the controller outputs the contact detection signal as the contact determination signal when the contact estimation coordinates agree with the contact position coordinates.

5. The electronic apparatus according to claim 4, wherein
assuming that an angular velocity signal around the Y axis is defined as X1, a maximum value in a detection range of the angular velocity signal around the Y axis is defined as X2, an angular velocity signal around the X axis is defined as Y1, and a maximum value in a detection range of the angular velocity signal around the X axis is defined as Y2, contact estimation coordinates (X, Y) are determined based on equation (2) and equation (3),
$$\begin{matrix}X = \frac{X 1}{\vert X 2 \vert} \\ where , - \vert X 2 \vert \leq X 1 \leq \vert X 2 \vert , \\ and & ( 2 ) \\ Y = \frac{Y 1}{\vert Y 2 \vert} \\ where , \\ - \vert Y 2 \vert \leq Y 1 \leq \vert Y 2 \vert . & ( 3 )\end{matrix}$$

6. The electronic apparatus according to claim 1, wherein
the controller outputs the contact detection signal as the contact determination signal when duration of detection of the contact detection signal is a predetermined threshold or longer.

7. The electronic apparatus according to claim 1, wherein
the operation surface of the touch panel has an origin at a center of the touch panel and is disposed on coordinates defined by an X axis and a Y axis orthogonal to each other, and
the controller outputs the contact detection signal as the contact determination signal when a value of the contact detection signal along the Y axis is positive and the angular velocity indicated by the angular velocity signal directs counterclockwise with respect to a positive direction of the X axis, or when a value of the contact detection signal along the Y axis is negative and the angular velocity indicated by the angular velocity signal directs clockwise with respect to a positive direction of the X axis.

8. The electronic apparatus according to claim 1, wherein
the operation surface of the touch panel has an origin at a center of the touch panel and is disposed on coordinates defined by an X axis and a Y axis orthogonal to each other, and
the controller outputs the contact detection signal as the contact determination signal when a value of the contact detection signal along the X axis is positive and the angular velocity indicated by the angular velocity signal directs counterclockwise with respect to a positive direction of the Y axis, and when a value of the contact detection signal along the X axis is negative and the angular velocity indicated by the angular velocity signal directs clockwise with respect to a positive direction of the Y axis.

9. The electronic apparatus according to claim 1, further comprising
a casing supporting the touch panel,
wherein, when the contact detection signal is not input, the acceleration signal is input, and the angular velocity signal is input, the controller determines that an input operation to the casing is performed, and outputs an input determination signal.

10. The electronic apparatus according to claim 9, wherein
the controller determines a position of an input operation to the casing based on a direction and a magnitude indicated by the acceleration signal and a rotation direction indicated by the angular velocity signal.

11. An electronic apparatus comprising:
a touch panel having an operation surface, detecting contact with the operation surface, and outputting a contact detection signal;
a casing supporting the touch panel;
an acceleration detector for detecting an acceleration of the electronic apparatus and outputting an acceleration signal;
an angular velocity detector for detecting an angular velocity of the electronic apparatus and outputting an angular velocity signal; and
a controller connected to the touch panel, the acceleration detector, and the angular velocity detector, and operable to output a contact determination signal based on the contact detection signal, the acceleration signal, and the angular velocity signal, and to determine that an input operation to the casing is performed, and outputs an input determination signal when the contact detection signal is not input, the acceleration signal is input, and the angular velocity signal is input.

12. The electronic apparatus according to claim 11, wherein
the controller determines a position of an input operation to the casing based on a direction and a magnitude of the acceleration indicated by the acceleration signal and a rotation direction of the angular velocity indicated by the angular velocity signal.
